(19) United States
(12) Patent Application Publication
(10) Pub. No.: US 2025/0259230 A1
(43) Pub. Date: Aug. 14, 2025

(54) METHOD AND SYSTEM TO PROVIDE A PRODUCT INTERACTION

(71) Applicant: LULULEMON ATHLETICA CANADA INC., Vancouver (CA)

(72) Inventors: Samuel Haskel BERGMANN-GOOD, Vancouver (CA); Stephen Robert GARLAND, Vancouver (CA); Ellisa Kathleen CALDER, Vancouver (CA); Justin Daniel MACCARTHY, Vancouver (CA); Jeremy Kevin TUCKER, Vancouver (CA); Sydney Taylor Therese KIDD, Vancouver (CA); Michael Christopher ARAGON, Vancouver (CA); Kristie D'AMBROSIO-CORRELL, Vancouver (CA); William LY, Vancouver (CA)

(21) Appl. No.: 18/866,013

(22) PCT Filed: Jun. 21, 2023
(86) PCT No.: PCT/CA2023/050862

§ 371 Date: Nov. 14, 2024

Related U.S. Application Data
(60) Provisional application No. 63/354,582, filed on Jun. 22, 2022.

(51) Int. Cl. G06Q 30/0601; G06Q 30/018

(52) U.S. Cl. CPC G06Q 30/0643; G06Q 30/0185

(57) ABSTRACT

Embodiments described herein relate to systems and methods for authenticating a candidate product in a rendering of a first user and a candidate product to determine whether the candidate product is an authentic branded product and generating a branded product interaction which is provided to a second user. The system generates digital instructions and outputs for an online web application, device hosted application, smart device, or similar system. In one embodiment, the system provides the branded product interaction that matches device capacity, user context, and product availability.

### FIELD

The present disclosure relates to methods and systems for electrical computers, digital processing, computer interfaces, online retail, smart devices, digital classes and environments, monitoring, physiological states, asset tagging, providing product information, machine learning, digital simulation, and retail integrations.

### INTRODUCTION

People often prefer to purchase products that they have seen others wearing or using. In less formal interpersonal interactions, people will often inquire about a product they see another person wearing. In particular, in some digital experiences, it is not appropriate and/or possible to make such inquiries. Example experiences include: when participants are muted, chat is disabled, participants are engaged in a shared activity, participants are interacting with others who speak different languages than they are able to speak, participants are interacting with participants they have not met in person and are not comfortable asking for information, there are a large number other participants involved, and so on.

Although some people are experts at identifying the brand of a product, others struggle to identify the brand associated with a product and may rely on a visible logo or other means of identification. Being able to identify a brand may be important to potential consumers wishing to purchase an item, current owners of an item who may personally identify as having a relationship to a specific brand or lifestyle associated with a brand, and other people who may form affiliations based on having a perceived shared relationship to a specific brand or lifestyle associated with a brand.

Embodiments described herein involve automated computer systems for receiving inputs, performing measurements, identifying a user, the context represented by an input, identifying the medium of an input, identifying a candidate product displayed within an input, identifying an authenticated branded product within an input, constructing data objects, applying data models, calculating instructions for providing product information and purchase options, indicating product authenticity, transforming data sets, changing states of electronic devices, and providing product information and/or purchasing options to the user.

Embodiments described herein involve automated computer systems and machine learning systems for automatically identifying branded assets based on factors such as purchase history, RFID (Radio Frequency Identification), NFC (Near Field Communication Technology), UV sensitive IDs, digital watermarks, physical watermarks, tokens, product fingerprinting, ID tags, other product embedded identifiers, image scanning, video scanning, and the like.

### SUMMARY

In an aspect, embodiments described herein provide systems, computer products, and methods for receiving an input depicting a first user and a displayed candidate product, determining whether the displayed candidate product is an authentic branded product, generating a product interaction related to the authenticated displayed branded product for a second user with non-transitory memory storing data related to products, users, retail, contexts, and product interactions, and instructions executed by a hardware processor to generate one or more sets of product interaction instructions. These instructions are then interpreted by an output device to activate or trigger one or more branded product interactions. In some embodiments, instructions are provided to augment a first user representation with an indication that an associated product interaction is available. In an aspect, embodiments described herein provide, to a second user, a branded product interaction, also referred to as a product interaction, based on an input depicting a first user and a displayed candidate product which is authenticated as a displayed branded product.

This summary does not necessarily describe the entire scope of all aspects. Other aspects, features and advantages will be apparent to those of ordinary skill in the art upon review of the following description of specific embodiments.

One aspect is a non-transitory computer readable medium with instructions stored thereon, that when executed by a hardware processor causes the processor to generate output instructions for a product interaction. The processor generates the output instructions for a product interaction based on an input depicting a user and a candidate product. The input may be one or more of a still image, snapshot, moving image, real-time live stream, near real-time stream, recorded video stream, a virtual reality snapshot, a virtual reality stream, a recorded virtual reality stream, an augmented reality snapshot, an augmented reality stream, and/or a recorded augmented reality stream. The input is also referred to as a rendering and/or depiction.

In some embodiments, the first user is wearing the one or more candidate products on their body as an item of apparel and/or using the candidate product as an accessory.

In some embodiments, the executable instructions identify whether there is a potential candidate product. In some embodiments the user indicates that the image or video contains a candidate product for authentication. The input may depict more than one user and/or more than one candidate product. Metadata associated with the user is also received. In some cases, the user may be logged in and have a user profile associated with their identity, and in other cases the user may be anonymous. Authenticating whether the one or more displayed candidate products are associated with a branded product to determine whether one or more authenticated displayed products includes techniques such as visual identification of the candidate product, scanning sensors, comparing aspects of the candidate product to data and aspects associated with branded products which the candidate product may potentially match, associating the candidate product with the depicted user and evaluating whether one or more pre-authenticated branded products are associated with the user, and the like. If the depiction includes an authenticated branded product one or more product interactions are generated.

A product model containing branded products is applied to the authenticated branded product. This provides additional information about the branded product, including such aspects and features as availability, product type, product associated sizes, colors, and versions, product associated activities, product associated descriptive and other collateral, and the like.

A product interaction may be a composite of multiple product interactions in combination. There are many types of potential product interactions that may be generated such as one or more of adding the displayed branded product to a view history, adding the displayed branded product to a customized storefront, adding identification values associated with the displayed branded product to an incentive system, displaying a virtual closet tour associated with the branded product, displaying environmental and/or sustainability factors associated with a branded product, displaying a 360 degree view of the product, displaying an interactive simulation of the product, displaying a pop-up with additional product details for the displayed branded product, providing a link to purchase the displayed branded product, providing a link to receive a special offer related to the displayed branded product, displaying an interactive product site for the displayed branded product, providing a link to related products for the displayed branded product, providing a link to other products related to the user associated with the displayed branded product, displaying activities associated with the displayed branded product, displaying activities associated with the first user associated with the displayed branded product, displaying communities associated with the displayed branded product, and/or displaying communities associated with the first user associated with the displayed branded product. A product interaction can involve displaying visualizations at an interface of a display of an electronic device, or providing overlays on the interface to dynamically update the display. In some embodiments, the closet tour can involve use of a simulation environment representing a physical environment (e.g. its closet and garments), and a digital twin representing the user in the simulation environment. A digital twin maps physiological outputs related to the user and garments for the simulation environment. The simulation environment can generate simulation data relating to the digital twin to estimate or predict attributes of the garments and the user in a physical environment (e.g. its closet) with similarities to the simulation environment. The digital twin can be used to define personalization data relevant to a given user. The system 100 can train or update models using feedback data and output as a feedback loop for the digital twin and simulation environment, which can change the simulation for the digital twin. The closet tour can involve one or more personality components that can be based on personality factors that measure or estimate different aspects of a user's personality.

In some embodiments, new types of product interactions are generated by machine learning within a trained product interaction model which refines and develops the types, and combinations of product interactions that the system provides.

In some embodiments, when multiple branded products are identified in the rendering, they are combined into a single product interaction that enables a second user to engage with them in combination. One example of this defines an “outfit” which may be viewed, added to a wishlist, purchased, or the like such that the combination of authenticated branded products is treated as if they were a single product unit with components. In some embodiments, when the authenticated branded product is not preferred a product interaction is generated for a substitute product identified as having comparable aspects to the depicted authenticated branded product. This may be based on such aspects availability, availability in a region, size, gender, preferred color, season, newer versions of the product, and the like.

Generating instructions to provide a product interaction for the branded product associated with the one or more authenticated displayed products includes generating a template for the product interaction, partially generating the product interaction, and fully generating the product interaction. In some embodiments, a product interaction is stored in an interaction repository 68 and/or online retail 85.

In some embodiments, there is a graphical representation of the first user and candidate product input in a user interface and there are executable instructions to add to this graphical representation associated with the first user input an indicator that there are one or more product interactions associated with the first user input. In some embodiments, there are executable instructions to receive from a second user an input engaging with the indicator that there are one or more product interactions associated with the first user input representation and provide the product interaction.

In some embodiments, there are executable instructions to pre-authenticate a branded product, generate data identifying the pre-authenticated branded product, and associate the data identifying the pre-authenticated branded product data with a user. In some embodiments, these instructions further comprise instructions to enable a user to add custom content comprising one or more of an image, video, audio recording, text entry, rating, review, testimonial, unboxing, demonstration, styling suggestion, outfit combination suggestion, wardrobe context, exercise suggestion, and/or usage suggestion, associated with the pre-authenticated branded product. In some embodiments, the instructions for authenticating whether the candidate product is associated with a branded product further comprise evaluating the pre-authenticated branded product data associated with the first user.

The product interaction generated may include executable instructions for one or more of the following: adding the displayed branded product to a view history; adding the displayed branded product to a customized storefront; adding identification values associated with the displayed branded product to an incentive system; displaying a closet tour associated with the branded product; displaying environmental and/or sustainability factors associated with a branded product; displaying a 360 degree view of the product; displaying an interactive simulation of the product; displaying a pop-up with additional product details for the displayed branded product; providing a link to purchase the displayed branded product; providing a link to receive a special offer related to the displayed branded product; displaying an interactive product site for the displayed branded product; providing a link to related products for the displayed branded product; providing a link to other products related to the user associated with the displayed branded product; displaying activities associated with the displayed branded product; displaying activities associated with the first user associated with the displayed branded product; displaying communities associated with the displayed branded product; and/or displaying communities associated with the first user associated with the displayed branded product.

The executable instructions for authenticating whether the one or more candidate products are associated with a branded product, may include instructions for authenticating the candidate product is a branded product by detecting and reading one or more of a 1D (linear) barcode, 2D barcode, 3D barcode, watermark, microtext, hologram, forensic taggants, a sensor, circuit, printed code, UV code, infrared code, printed smart tag, smart token, Radio Frequency Identification (RFID) technology tag, Bluetooth Low Energy (BLE) tag, and/or Real-Time Locating Systems (RTLS) tag within, attached to, or on the candidate product.

One aspect is a computer implemented method for generating output instructions for a product interaction with a branded product is the method comprising, receiving, using a hardware processor, input data that includes a rendering of a first user and a candidate product; receiving, using a hardware processor, metadata related to the rendering of a first user and a candidate product; identifying, using a hardware processor, the first user associated with the rendering; authenticating, using a hardware processor, based on the rendering and the metadata, whether the candidate product displayed is a branded product; retrieving additional data associated with the product; generating a branded product interaction.

In some embodiments, the method for generating output instructions for a product interaction with a branded product further comprises evaluating whether the rendering of a first user and a candidate product contains a sufficient visible portion of the candidate product to identify whether the candidate product is an authentic branded product. The sufficient visible portion may be based on the clarity of the rendering, the percentage of the candidate product visible in the rendering, the identifying aspects of the candidate product visible in the rendering, the lighting of the candidate product, the velocity and or momentum of the candidate product, and the like. In some embodiments, the method for generating output instructions for a product interaction with a branded product is applied to an item of apparel.

In some embodiments, the method identifies whether there are more than one candidate products within the rendering of a first user and a candidate product. In some embodiments, if there are more than one candidate products, the method authenticates each of the candidate products displayed. In some embodiments, the method prioritizes authenticating one of the more than one candidate products. In some embodiments, the method authenticates one candidate product based on one or more of such factors as a user rating, a pre-authentication status, a user favorite status, a retail promotion, the newness of the product, a featured product status, a user selection when providing the input depicting a first user and one or more candidate products.

In some embodiments, when multiple candidate products are identified the method generates a product interaction that combines each of the more than one candidate product in a combined product interaction. An example of such product interaction would be view the outfit, buy the outfit, or buy the set of work out accessories and/or gear.

In some embodiments of the method, identifying the first user associated with the rendering further comprises identifying an anonymous user instance and validating the product authenticity based on specific aspects related to the product.

In some embodiments, the method receives one or more of a user model, a product model, and/or a retail model. In some embodiments, the method for generating output instructions for a product interaction with a branded product includes evaluating the candidate product against one or more of a product model, a user model, and/or pre-authenticated branded product metadata associated with user data to authenticate whether the candidate product is a branded product. A number of different product interaction types such as a customized storefront, adding identification values associated with the displayed branded product to an incentive system, displaying a closet tour associated with the branded product, displaying environmental and/or sustainability factors associated with a branded product, displaying a 360 degree view of the product, displaying an interactive simulation of the product, displaying a pop-up with additional product details for the displayed branded product, providing a link to purchase the displayed branded product, providing a link to receive a special offer related to the displayed branded product, displaying an interactive product site for the displayed branded product, providing a link to related products for the displayed branded product, providing a link to other products related to the user associated with the displayed branded product, displaying activities associated with the displayed branded product, displaying activities associated with the user associated with the displayed branded product, displaying communities associated with the displayed branded product, displaying communities associated with the user associated with the displayed branded product may be generated.

In some embodiments candidate product authentication further comprises evaluating the candidate product against one or more of a product data model, and/or pre-authenticated branded product metadata associated with user data. In some embodiments, the method evaluates whether the authentic branded product is available in a specific region, market, gender designation, color, size, pattern, version, membership level, and/or season. In some embodiments, includes instructions to determine a substitute branded product based on one or more of the authenticated displayed product availability in an inventory, availability in a preferred region, availability in a preferred size, availability in a preferred option, an updated model associated with the branded product, or the like.

In some embodiments, authenticating the candidate product includes further executable instructions to authenticating that the candidate product is a branded product by detecting and reading one or more of a 1D (linear) barcode, 2D barcode, 3D barcode, watermark, microtext, hologram, forensic taggants, a sensor, circuit, printed code, UV code, infrared code, printed smart tag, smart token, RFID technology tag, BLE tag, and/or RTLS tag within, attached to, or on the candidate product.

In some embodiments, generating output instructions for a product interaction with a branded product may include generating a product interaction template for multiple types of product interaction instances. In some embodiments, when generating a product interaction there are further methods for storing a product interaction in a repository, evaluating a stored interaction against a request for a product interaction, partially regenerating a product interaction, augmenting a product interaction, regenerating a product interaction. In some embodiments, generating or regenerating a product interaction includes instructions to a graphical representation associated with the first user input an indicator that there are one or more product interactions associated with that first user input. In some embodiments, the method further comprising receiving an input from a second user engaging with this interaction indicator and providing the product interaction to the second user. In some embodiments, metadata associated with a second user such as one or more of a user region, user size, user purchase history, user wishlist, user viewed product list, user activity, user activity history, user planned activity, and/or user preference associated with color, feel state, activity, fabric type, is received.

In one aspect, there is a computer implemented method for providing executable output instructions for a product interaction with a branded product the method comprising receiving, using a hardware processor, input data that includes a rendering of a first user and a candidate product; receiving, using a hardware processor, metadata related to the rendering of a first user and a candidate product; identifying, using a hardware processor, the first user associated with the rendering; authenticating, using a hardware processor, based on the rendering and the metadata, whether the candidate product displayed is a branded product; retrieving additional data associated with the product; generating a branded product interaction, receiving a request for the product interaction from a second user, evaluating the request, providing one or more branded product interactions.

In some embodiments, the method includes executable instructions to display one or more indications that a product interaction is available associated with the first user image and/or video. In some embodiments, the position and/or size of the first user image and/or video within a graphical user interface provides an indication of the availability of a product interaction. In some embodiments, the computer implemented method for providing output instructions for a product interaction includes adding to a graphical representation associated with the first user input an indicator that there is one or more product interactions associated with the first user input. This indicator type may be one or more of featuring, profile circles, changes to translucency, indicators, highlighting, color coding identifiers, symbols, awards, location of a stream/image within a user interface, buttons, badges, shimmer effects, motion blurring, popping, changing a background, and/or adding identification values associated with the displayed branded product to a dashboard or trend analysis.

In some embodiments, the method receives from the first user, depicted with the candidate product, values indicating one or more of a preferred interaction type, a custom content comprising one or more of an image, video, audio recording, text entry, rating, review, testimonial, styling suggestion, outfit combination suggestion, wardrobe context, exercise suggestion, and/or usage suggestion, to a pre-authenticated branded product.

In some embodiments, receiving a request from a second user includes receiving data associated with one or more of second user authentication, user region, activity history, wishlist, size, purchase history, context, device capacity, and/or preference. In some embodiments, the second user device is evaluated based on factors such as device capacity for displaying images, video, audio, screen size, resolution, input, output, capacity for printing, capacity for interactive billboard type display, capacity for augmented reality, capacity for virtual reality, capacity for mixed reality and generate a product interaction that matches second user device capacities. In some embodiments, generating a product interaction includes generating based on one or more of second user device capacity, context, user region, and/or user retail other data associated with the second user.

The product interaction may be one or more of adding the displayed branded product to a view history, adding the displayed branded product to a customized storefront, adding identification values associated with the displayed branded product to an incentive system, displaying a closet tour associated with the branded product, displaying environmental and/or sustainability factors associated with a branded product, displaying a 360 degree view of the product, displaying an interactive simulation of the product, displaying a pop-up with additional product details for the displayed branded product, providing a link to purchase the displayed branded product, providing a link to receive a special offer related to the displayed branded product, displaying an interactive product site for the displayed branded product, providing a link to related products for the displayed branded product, and/or providing a link to other products related to the user associated with the displayed branded product.

In some embodiments, the computer implemented method for providing output instructions for a product interaction provide the product interaction when the second user completes or starts a specific activity.

In one aspect, there is a computer system for providing a user device with a branded product interaction associated with a specific authenticated branded product depicted in a rendering of a first user and one or more branded products. The system comprises a communication interface to transmit the branded product interaction associated with a specific authenticated branded product; one or more non-transitory memory storing trained interaction models, a product model, and a user model; a hardware processor programmed with executable instructions for generating the branded product interaction associated with a specific branded product depicted in a rendering of a first user and one or more branded products, wherein the hardware processor: receives a rendering of a first user and a candidate product; receives input data associated with the rendering including user data and context; evaluates the rendering to determine whether the candidate product is an authentic branded product based on product data, user data, and product data associated with user data; receives product data associated with an authenticated branded product; determines one or more product interaction types to generate based on the intervention model, branded product data, product type data, and context data; generates one or more product interactions; evaluates displaying a product interaction indication in association with a representation of the rendering of a first user and one or more branded products; receives a second user engagement with the representation of the rendering of a first user and one or more branded products; provides to the second user the one or more product interactions; a user device comprising a hardware processor, and an interface to receive the branded product interaction; and activate or present the product interaction.

In some embodiments, the executable instructions to evaluate the rendering of a first user and a candidate product further comprise instructions to recognize visual aspects depicted in an image or video input. In some embodiments, the system further comprises a product authenticator with executable instructions to authenticate a candidate product as an authentic branded product and associate the authentic branded product with a user. In some embodiments the instructions to evaluate the rendering to determine whether the candidate product is an authentic branded product further comprise evaluating authentic branded products associated with the user.

In some embodiments, the system further comprises an interaction repository to store one or more of generated product interactions, product interaction types, product interaction templates, and/or partially generated product interactions. In some embodiments, the executable instructions to evaluate displaying a product interaction indication further comprise evaluating the context associated with the representation of the rendering of a first user and one or more branded products within the product interaction indication.

In some embodiments, the system further comprises an online retail application with executable instructions to receive a trigger from the user device. In some embodiments, the user device is a smart mirror. In some embodiments, the system further comprises a user device comprising a hardware processor, and an interface to provide a rendering of a first user and a candidate product, input data associated with the rendering.

In some embodiments of the system, one or more of the trained intervention model, product model, and/or user model stored in the memory is updated by the hardware processor based on machine learning. Machine learning may be based on one or more of second user engagement, second user purchases, second user feedback, and the like.

In one aspect, there is a computer system for generating a branded product interaction associated with a specific authenticated branded product depicted in a rendering of a first user and one or more branded products. The system comprises communication interface to receive a rendering of a first user and a candidate product; one or more non-transitory memory storing trained interaction models, a product model, and a user model; a hardware processor programmed with executable instructions for generating the branded product interaction associated with a specific branded product depicted in a rendering of a first user and one or more branded products, wherein the hardware processor: receives a rendering of a first user and a candidate product; receives input data associated with the rendering including user data, context; evaluates the rendering to determine whether the candidate product is an authentic branded product based on product data, user data, and product data associated with user data; receives product data associated with an authenticated branded product; determines one or more product interaction types to generate based on the intervention model, branded product data, product type data, and context data; generates one or more product interactions; a user device comprising a hardware processor, and an interface to provide a rendering of a first user and a candidate product, input data associated with the rendering.

In some embodiments, the executable instructions to evaluate the rendering of a first user and a candidate product further comprise instructions to recognize visual aspects depicted in an image or video input. In some embodiments, the system further comprises a product authenticator with executable instructions to authenticate a candidate product as an authentic branded product and associate the authentic branded product with a user. These instructions to evaluate the candidate product may further comprise evaluating authentic branded products associated with the user.

In some embodiments, the system provides an interaction repository to store one or more of generated product interactions, product interaction types, product interaction templates, partially generated product interactions. In some embodiments, the user device is a smart mirror. In some embodiments, the system includes a retail model. In some embodiments, the system includes an online retail application.

In some embodiments, the system includes devices for authenticating the candidate product is a branded product by detecting and reading one or more of a 1D (linear) barcode, 2D barcode, 3D barcode, watermark, microtext, hologram, forensic taggants, a sensor, circuit, printed code, UV code, infrared code, printed smart tag, smart token RFID technology tag, BLE tag, and/or RTLS tag within, attached to, or on the candidate product.

In some example embodiments, the system involves receiving input, for visual authentication, using lidar scanning. The system can use computer vision to receive input. Computer vision may be based on pixel to pixel comparison, color comparison, logo placement, design patterns on the surface, or embedded, such as QR codes and similar identification means.

In some embodiments, there may be pre-authenticated branded products associated with a user profile (e.g. a labeled data set), and data associated with those products can be used for authentication. Example data includes version, season, year where logo placement and/or other product identification means may be different for different products. From a user profile, data such as purchase history, pre-authentication, location or region may be used to reduce the set of garments to be authenticated. For chips associated with or potentially applied in conjunction to computer vision authentication, RFID, Ultra-wideband (UWB) have greater range for sensor detection. The system can use different types of product marking such as UV, InfraRed, internal light/energy reactive elements (similar to x-ray) printing on, embedding in, and/or containing products to extract or obtain data about the products. There are a number of candidates for product authentication and different combinations of data based on user profile and visual detection can be used.

In some embodiments, an RFID transponder system is provided. With user devices and/or Input devices and/or components including an antenna/interrogator functioning type component for receiving RFID information from a RFID chip, label, and/or tag on or within the candidate product. In some embodiments, the authentic branded product contains an RFID chip, label, or tag component which may be a factor used to determine authenticity. The RFID transponder may be Ultra-High Frequency (UHF), High Frequency (HF) and/or Near Field Communication (NFC), Low Frequency (LF), Dual Frequency Ultra-High Frequency (DFUHF) and NFC, or a combination thereof. In some embodiments, Ultra-High Frequency is preferred for its range, speed, and capacity with a dense tag population and/or movement.

In one embodiment, the system can detect the authenticated branded product displayed by a user (such as an instructor or leader) and send to a second user data or information about this outfit prior to a class so that the second user is able to purchase a matching outfit prior to the class. For example, this may be based on a rebroadcast of a class or a planned outfit (potentially pre-authenticated) for an upcoming live class.

In some embodiments, the system includes instructions for authenticating that the candidate product is a branded product by detecting and reading one or more of a 1D (linear) barcode, 2D barcode, 3D barcode, watermark, microtext, hologram, forensic taggants, a sensor, circuit, printed code, UV code, infrared code, printed smart tag, smart token, RFID technology tag, BLE tag, and/or RTLS tag within, attached to, or on the candidate product. The system uses different hardware components to implement the authentication.

### BRIEF DESCRIPTION OF THE DRAWINGS

Embodiments of the disclosure will now be described in conjunction with the accompanying drawings of which:

FIG. 1 shows an example system architecture for generating and/or providing a product interaction based on an input depicting a user and a candidate product, according to embodiments described herein.

FIG. 2 shows an example system architecture for generating and/or providing a product interaction based on an input depicting a user and a candidate product, according to embodiments described herein.

FIG. 3 shows an example method of generating a product interaction based on an input depicting a first user and a candidate product, according to embodiments described herein.

FIG. 4 shows an example method associated with candidate product authentication, generating product interactions, and providing product interactions according to embodiments described herein.

FIG. 5 shows an example method of authenticating a candidate product, according to embodiments described herein.

FIG. 6 shows an example method of authenticating a candidate product, according to embodiments described herein.

FIG. 7 shows an aspect related to generating and/or providing a product interaction, according to embodiments described herein.

FIG. 8 shows an example method related to generating and/or providing a product interaction, according to embodiments described herein.

FIG. 9 shows an example method related to generating and/or providing a product interaction, according to embodiments described herein.

FIG. 10 shows an example method related to generating and/or providing a product interaction, according to embodiments described herein.

FIG. 11 shows an example user interface related to generating and/or providing a product interaction, according to embodiments described herein.

FIG. 12 shows an example user interface related to generating and/or providing a product interaction, according to embodiments described herein.

FIG. 13 shows an example user interface related to generating and/or providing a product interaction, according to embodiments described herein.

FIG. 14 shows an example user interface related to generating and/or providing a product interaction, according to embodiments described herein.

FIG. 15 shows an example method of generating a product interaction based on an input with additional steps for determining if a user is displaying an avatar in the user interface and displaying a digital version of an authenticated branded product, according to embodiments described herein.

FIG. 16 shows an example user interface related to generating and/or providing a product interaction with an overlay effect, according to embodiments described herein.

### DETAILED DESCRIPTION

The methods and systems involve a hardware processor having executable instructions to provide one or more generated product interactions based on an input depicting a first user and one or more displayed candidate products. In embodiments, the displayed candidate product is an item of apparel worn by the first user, a fitness accessory, exercise mat, or other equipment. Embodiments involve sensors that perform measurements for receiving input. For example, the sensors can perform measurements for receiving input for images or videos that include the user, the product and its environment. The hardware processor can receive input data from the verification and scans, and process the measurements for the input. Embodiments include systems, methods, and instructions to authenticate that the candidate product matches a branded product associated with product data, retail data, and the like within the systems, methods, and instructions. In some embodiments, at least one sensor performs measurements for receiving input and/or a rendering of the first user and the candidate product. The sensors can perform different types of measurements to obtain or receive different types of data for various embodiments.

These generated product interaction instructions are then transmitted to and interpreted by an application and/or output device to activate, display or trigger one or more product interactions, or provide the second user with one or more product interactions. In an aspect, embodiments described herein provide, to a second user, a product interaction based on an input depicting the first user and a candidate product, also referred to as an interaction.

Embodiments relate to methods and systems with non-transitory memory storing instructions and data records for product characterization, user characterization, purchase characterization, and product interaction characterization. Embodiments relate to generating and providing a product interaction based on data and data models associated with the first user, the second user, a branded product, a user context, user device capacity, retail offerings, retail inventory, and the like.

Embodiments described herein can provide improved methods and systems for providing the user with a branded product interaction or activating or triggering one or more product interactions associated with a branded product. The provision of the branded product interaction can involve controlling display of visualizations relating to the product interaction on a user interface of a display of an electronic device.

Embodiments described herein provide a product interaction to a second user. The interaction enables the second user to engage with a product which the second user has seen a first user wearing, using, and/or displaying. Examples of product interaction types include adding the displayed branded product to a viewed product history, adding the displayed branded product to a customized storefront, adding identification values associated with the displayed branded product to a dashboard or trend analysis, adding identification values associated with the displayed branded product to an incentive system, displaying a closet tour associated with the branded product, displaying environmental and/or sustainability factors associated with a branded product, displaying a 360 degree view of the product, displaying an interactive simulation of the product, displaying a pop-up with additional product details related to the displayed authentic branded product, providing a link to purchase the displayed branded product, providing a link to purchase more than one authenticated branded products in combination (by an outfit), providing a link to purchase the branded product in the second user's size, preferred color, preferred region, providing a link to receive a special offer related to the displayed branded product, displaying an interactive product site for the displayed branded product, providing a link to related products for the displayed branded product, providing a link to other products related to the user associated with the displayed branded product, and combinations of such interactions.

Embodiments described herein can provide improved methods and systems for providing the user with product information, a purchase option, an enhanced digital experience such as a concert, class, or group activity. Embodiments relate to generating and providing a product interaction based on data and data models associated with users (e.g. a first user, a second user), a branded product, a user context, user device capacity, retail offerings, retail inventory, and the like. The terms “first user” and “second user” are used to denote activities that can be performed by distinct users, although these activities may also be performed by the same user. In some examples, within the system more than one user would perform the first user activities and more than one user would perform the second user activities.

Embodiments described herein provide a product interaction to a user. The product interaction is determined based on a still, streamed, or recorded image or series of images depicting a first user and one or more candidate products, determining that a depicted candidate product matches an authentic branded product that is depicted, associating data in a product model and/or retail model with the identified branded product.

Embodiments of the disclosure provide methods and systems for determining a type of product interaction (e.g. an appropriate or optimal type of product interaction), and an indication associated with a product interaction. Embodiments of the disclosure provide methods and systems for generating the product interaction, and improving the system capacity to provide a product interaction that is accepted by the user, supports the user in engaging with an activity, community, or retail experience and/or provides additional customized educational and retail experiences associated with a branded product.

Product interactions may involve various media types and combinations of various media types. Example media types include video, interactive presentation, game, image, hologram image projection, autostereoscopic image projection, audio, text, spoken word, guided conversation, email, SMS (short message service) message, MMS (multimedia messaging service) message, music, and interactive simulation. The media may be selected as a product interaction, either independently or combined with other types of product interactions. Examples of media associated with product interactions include a user unboxing video, a product demonstration, a virtual reality engagement with a product, a simulated engagement with a product, a change room type experience, and a chat experience related to the product. In some embodiments, the change room type experience can involve use of a simulation environment representing a physical environment (e.g. its closet and garments), and a digital twin representing the user in the simulation environment. A digital twin maps physiological outputs related to the user and garments for the simulation environment. The simulation environment can generate simulation data relating to the digital twin to estimate or predict attributes of the garments and the user in a physical environment with similarities to the simulation environment. A digital twin can have a visual representation in the simulation environment, such as an avatar.

In an embodiment, a product interaction may further involve executable instructions to present, remove, unlock, or customize one or more of a retail offer, a retail experience, a user profile, user wish list of products or services, a workshop, coaching session, lecture, performance event, community event, an exercise class, an avatar, an avatar's clothing, a conversational interaction, a notification, a pop-up suggestion, an alarm, a badge, and/or a group membership.

A product interaction may be provided in different ways and/or using different devices, including, for example, one or more of a web application, an application installed on a user device, a smart mirror device, a connected music system, a connected exercise mat, a connected smell diffuser device, a virtual reality headset, an augmented reality headset, a metaverse headset, a haptic glove, a game controller, a haptic garment, a retail application, a coaching application, a fitness class or studio application, an email system, a text message system, notification system, augmented reality environment, simulated reality environment, virtual reality environment, a game environment, and/or a metaverse or virtual environment. A product interaction may be provided in a combination of different ways and/or different devices. Product interactions may be evaluated automatically by one or more hardware processers based on their capacity to engage a second user.

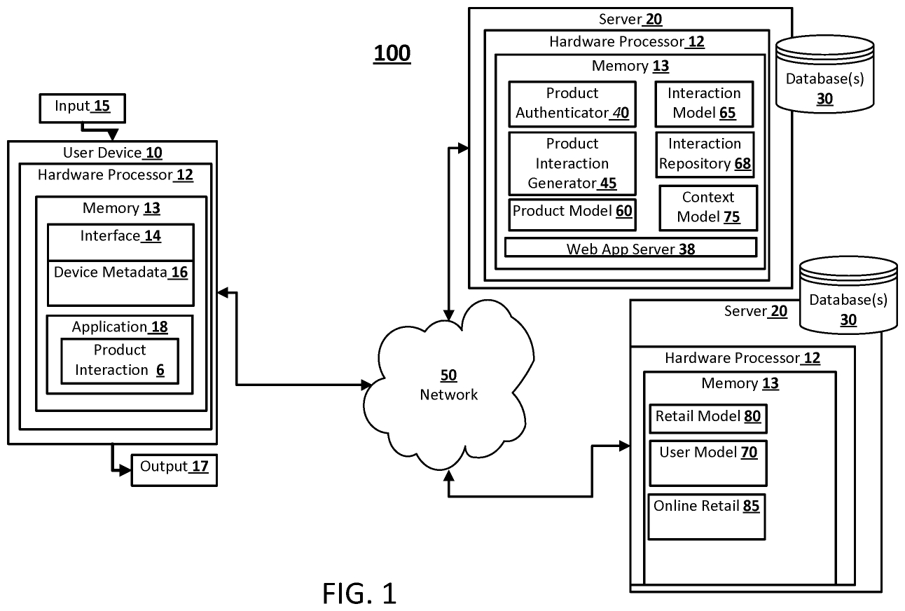

Turning to FIG. 1, there is shown an embodiment of a product interaction system 100 that may generate and/or provide one or more product interactions based on an input depicting a first user and a displayed candidate product, product interaction system 100 may implement operations of the methods described herein. Product interaction system 100 has hardware servers 20, databases 30 stored on non-transitory memory, a network 50, and user devices 10, and one or more controllers or sensors. Servers 20 have hardware processors 12 that are communicatively coupled to databases 30 stored on the non-transitory memory and are operable to access data stored on databases 30. Servers 20 are further communicatively coupled to user devices 10 via network 50 (such as the Internet). Thus, data may be transferred between servers 20 and user devices 10 by transmitting the data using network 50. The user devices 10 includes non-transitory computer readable storage medium storing instructions to configure one or more hardware processors 12 to provide an interface 14 for collecting data and exchanging data and commands with other components of the system 100. The user devices 10 have one or more network interfaces to communicate with network 50 and exchange data with other components of the system 100. The servers 20 may also have a network interface to communicate with network 50 and exchange data with other components of the system 100. An input device of system 100 can include a sensor or controller that can perform measurements or operations relating to the product interaction. These measurements or operations can be used to define or identify authentic items. A controller can be an electronic device (e.g. as part of a control system) that generates control signals as output to control actions of the device or another device. For example, a controller can generate control signals with code that controls operations of a processor or peripheral device, actuate components of a device, and so on. A controller can be a chip, card, an application, or a hardware device. A controller can manage and connect devices, or direct the flow of data between devices to provide an interface and manage communication. For example, a controller can be an interface component between a central processing unit and a device being controlled. A controller can be a type of input device that generates and transmits control commands to control operations of a computer, a component, or other device. There are different types of controllers. Controllers automatically control products, embedded systems, and devices using control commands. A controller can have one or more processors, memory and programmable input/output peripherals. A sensor can be a device that detects or measures a physical property, records the detections or measurements, or transmits the detections or measurements. A sensor is a device that responds to a physical stimulus and generates a resulting measurement. A sensor can be a device, machine, or subsystem that detects events or changes in its environment, produces an output signal associated with sensing physical properties, and sends the information to other electronics, such as a hardware processor. Examples of sensors and controllers are disclosed herein in reference to, at least, input devices. In some embodiment, controller and/or sensors integrate with or form part of user devices 10.

A number of users of product interaction system 100 may use user devices 10 to exchange data and commands with servers 20 in manners described in further detail below. For simplicity of illustration, only one user device 10 is shown in FIG. 1, however, product interactions based on an input depicting a first user and a candidate product system 100 can include multiple user devices 10, or even a single user device 10. The user devices 10 may be the same or different types of devices. The product interaction system 100 is not limited to a particular configuration and different combinations of components can be used for different embodiments. Furthermore, while product interaction system 100 shows two servers 20 and two databases 30 as an illustrative example, interaction system 100 extends to different numbers of servers 20 and databases 30 (such as a single server communicatively coupled to a single database). The servers 20 can be the same for different types of devices.

The user device 10 has at least one hardware processor 12, a data storage device 13 (including volatile memory or non-volatile memory or other data storage elements or a combination thereof), and at least one communication or network interface 14. The user device 10 components may be connected in various ways including directly coupled or indirectly coupled via a network 50. The user device 10 is configured to carry out the operations of methods described herein.

The user device 10 may be a smart exercise device, or a component within a connected smart exercise system. Types of smart exercise devices include smart mirror device, smart treadmill device, smart stationary bicycle device, smart home gym device, smart weight device, smart weightlifting device, smart bicycle device, smart exercise mat device, smart rower device, smart elliptical device, smart vertical climber, smart swim machine, smart boxing gym, smart boxing bag, smart boxing dummy, smart grappling dummy, smart dance studio, smart dance floor, smart dance barre, smart balance board, smart slide board, smart spin board, smart ski trainer, smart trampoline, or smart vibration platform. Additional smart devices that can be used in such a system include a connected audio music system, a connected lighting system. User in such systems may also input data and/or receive product interactions through different devices such as a heart rate monitor, breathing monitor, a blood glucose monitor, an electronic implant, an EEG, and a brain-computer interface. A hologram projection system, an autostereoscopic projection system, virtual reality headset, an augmented reality headset, mixed reality devices, virtual reality devices, an augmented reality device, a metaverse headset, a haptic glove, a game controller, and a haptic garment, which may or may not be integrated in other devices.

The user device 10 functionality may be performed completely or in part by a shared user device accessed by more than one user. In one embodiment, the shared user device is a moving or stationary camera controller device (video, single, multi-frame capture) in a public or private space, such as a trail, race start location, gym, yoga studio, bike route, water access point, or the like. A first user may perform a “snap and go” at the beginning, mid-way through, or end of an activity or a combination thereof. Additional metadata such as time stamps, biometrics, activity type, authentication data, mood, gear associated with activity, and ratings, may be captured and associated with recorded visual input. In some embodiments, a user may use a token or other identification means, separately or in combination with providing recorded input and/or streamed input to trigger engagement with the product interaction system. In some embodiments sensors or other means of authentication for one or more of a 1D (linear) barcode, 2D barcode, 3D barcode, watermark, microtext, hologram, forensic taggants, a sensor, circuit, printed code, UV code, infrared code, printed smart tag, smart token, Radio Frequency Identification (RFID) technology tag, Bluetooth Low Energy (BLE) tag, and/or Real-Time Locating Systems (RTLS) tag within, attached to, or on the candidate product are integrated in or associated with user device 10. In some embodiments, the shared user interactive device contains or is associated with an output device, such as, a display output device, including, interactive touch screen, interactive billboard, audio or broadcast output, printer, 3D printer, token output device, ticket output device, previously manufactured object output mechanism, or the like.

Each hardware processor 12 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. Memory 13 may include a suitable combination of any type of computer memory that is located either internally or externally.

Each network interface 14 enables computing device 10 to communicate with other components, to exchange data with other components, to access and connect to network resources, to serve applications, and perform other computing applications by connecting to a network 50 (or multiple networks) capable of carrying data. The communication or network interface 14 can enable user device 10 to interconnect with one or more input devices, such as a keyboard, mouse, camera, touch screen and a microphone, or with one or more output devices such as a display screen and a speaker.

The memory 13 can store device metadata 16 which can include available metadata for factors such as memory, processor speed, touch screen, resolution, camera, video camera, processor, device location, haptic input/output devices, augmented reality glasses, and virtual reality headsets. The system 100 can determine device capacity for a product interaction or product interaction types by evaluating the device metadata 16, for example.

According to some embodiments, user device 10 is a mobile device such as a smartphone, although in other embodiments user device 10 may be any other suitable device that may be operated and interfaced with by a user. For example, user device 10 may comprise a laptop, a personal computer, an interactive kiosk device, immersive hardware device, smart mirror or a tablet device. User device 10, may include multiple types of user devices and may include a combination of devices such as smart phones, computers, and tablet devices, within system 100.

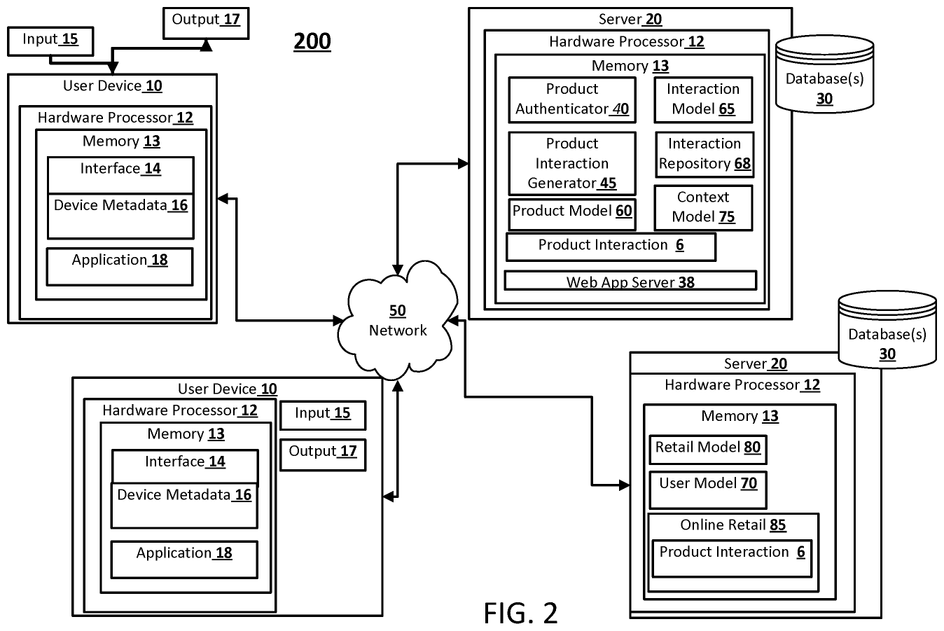

Turning to FIG. 1, the example server architecture includes a server 20 with product interaction generator 45 providing a product interaction 6 in application 18 to user device 10. In other example architectures, similar functionality is by server 20, web app server 38, or online retail 85 (FIG. 2). Executable instructions or code components such as product authenticator 40, product interaction generator 45, product model 60, interaction model 65, and interaction repository 68 may be installed on more than one server 20 within system 100. In some example architectures, product authenticator 40, and product interaction generator 45 may be installed on user device 10.

The server 20 has at least one hardware processor 12, a data storage device 13 (including volatile memory or non-volatile memory or other data storage elements or a combination thereof), and at least one communication or network interface. The server 20 components may be connected in various ways including directly coupled or indirectly coupled via a network 50. The server 20 is configured to carry out the operations of methods described herein.

User device 10 includes input and output capacity (via network interface 14 or I/O interface), a hardware processor 12, and computer-readable medium or memory 13 such as non-transitory computer memory storing computer program code. Input device 15 may be integrated within user device 10 or connected in various ways including directly coupled or indirectly coupled via a network 50. The input device can perform verifications and scans. For example, the input device can include (or couple to) one or more sensors that can capture verifiable images, codes, and IDs relating to a product, user, activity, or its environment or context. The sensors perform measurements for receiving input. For example, the sensors can perform measurements for receiving input for images or video that includes the user, the product and its environment. A hardware processor 12 can receive input data from the verification and scans, and process the measurements for the input. Similarly, output device 17 may be integrated within user device 10 or connected in various ways including directly coupled or indirectly coupled via a network 50. The output device 17 can activate, trigger, or present one or more product interactions over a time duration. For example, output device 17 can activate or trigger audio associated with a product interactions at a speaker device. As another example, output device 17 can present a visual indicator associated with a product interaction and/or a visual product interaction at a display device. As a further example, output device 17 can provide a virtual reality headset experience to enable a virtual experience type branded product interaction.

The product interaction may involve different types of devices to generate different types of discernible effects to provide a multi-sensory product interaction experience. In some embodiments, multiple branded product interactions can be provided over a time period. For example, a first product interaction can be provided at a first time, a second product interaction can be provided at a second time, and so on. In some embodiments, multiple product interactions can be provided simultaneously at a first time, and another product interaction can be provided a second time, and so on. In some embodiments, selected product interactions may be stored and provided at a later time. An example of this is a graphical user interface showing the second user a collection of product interactions with which they have recently engaged. User device 10 may be coupled with more than one input device 15, more than one output device 17, and more than one of both input device 15 and output device 17. A single device may contain input device 15 and output device 17 functionality, a simple example of this would be a connected headset with integrated microphone.

Turning to FIG. 1, there is shown an embodiment of a user device 10 where the application 18 includes executable instructions displaying information concerning providing product interactions 6. For example, in an embodiment application 18 may be an application providing streaming exercise content displayed on a smart mirror user device 10 which includes executable instructions related to the generating and/or providing of product interactions. Application 18 may be one or more applications provided by user device 10. For example, one application 18 program may provide functionality related to authenticating a candidate product and one application 18 may provide functionality related to providing a product interaction. Application 18 may provide a web browser type program, or other application that enables a user to access product interaction 6 stored on server 20 as shown in FIG. 2.

In some embodiments, the function of databases 30 may be implemented by servers 20 with non-transitory storage devices or memory. In other words, servers 20 may store the user data located on databases 30 within internal memory and may additionally perform any of the processing of data described herein. However, in the embodiment of FIG. 1, servers 20 are configured to remotely access the contents of databases 30, or store data on databases 30, when required.

Turning to FIG. 2, there is shown another embodiment of a user device 10 where the application 18 includes executable instructions for accessing product interaction on server 20. As shown in FIG. 2, product interaction 6 can be provided in memory 13 on server 20 and/or product interaction 6 may be provided in online retail 85 displaying information concerning product interactions.

In some embodiments, models include product model 60, interaction model 65, context model 75, user model 70, retail model 80. These models may be stored in memory 13, database 30. In some embodiments, interaction model 65 is integrated in interaction repository 68 and/or retail model is integrated in online retail 85.

The product interaction system 100 evaluates candidate displayed products (captured through verifications and scans and received as input data) to generate and/or provide a product interaction, and in conjunction with the product interaction generator 45, and in some embodiments, interaction model 65, and/or interaction repository 68 evaluates the type of interaction and generates the context aware branded product interaction. In some embodiments, the device metadata data 16 and/or application 18 functionality shown on user device 10 is integrated in online retail 85.

In some embodiments, the product interaction based on a first user and a displayed authenticated branded product (or interaction) is generated as executable instructions stored within application 18. In some embodiments the branded product interaction is streamed to user device 10 through network 50. The user device 10 and/or output device 17 may be a device such as a smart home peripheral device, smart exercise mirror, or a virtual reality connected device.

In some embodiments, an RFID transponder system is provided. User device 10 and/or input 15 include an antenna/interrogator functioning type component for receiving RFID information from a RFID chip, label, and/or tag on or within the candidate product. In some embodiments, the authentic branded product contains an RFID chip, label, or tag component which may be used to determine authenticity in conjunction with Product Authenticator 40. The RFID transponder may be Ultra-High Frequency (UHF), High Frequency (HF) and/or Near Field Communication (NFC), Low Frequency (LF), Dual Frequency Ultra-High Frequency (DFUHF) and near NFC, or a combination thereof. In some embodiments, UHF is preferred for its range, speed, and capacity with a dense tag population and/or movement.

The product interaction system 100 has non-transitory memory storing data records, context data, interaction data, user data, product data, retail data, and additional metadata received from a plurality of channels, at servers 20 and databases 30. For example, the data records can involve a wide range of data related to users, user types, user activity, user schedules, user regions, user size, user purchases, user context, activity types, user device capacity, feel-states, product descriptions, product types, product sizing, product availability, retail regions, retail offers, retail promotions, and device metadata. The data involves structured data, unstructured data, metadata, text, numeric values, images, biometric data, physiological data, activity data, renderings based on images, video, audio, sensor data, and so on.

For example, the contextual data includes data that pertains to the context for authenticating a candidate product, generating a product interaction, and providing a product interaction. For example, in embodiments, contextual data contains data identifying qualities such as specific contextual user data, user classification metadata, user current activity, user historical activity, current lighting, lighting history, specific contextual retail activity, categories of retail activity, specific contextual activity/movement profile data, categories of activity/movement profile data, specific contextual, specific feel state data, categories of feel state data, data, and so on. In some embodiments, input device 15 provides one or more element of the context data. In some embodiments, input device 15 provides one or more element of the data used to authenticate a candidate product.

There will now be described methods for generating product interactions for a user device 10 based on receiving an input (image and/or video) depicting a first user and displaying a candidate product, and product models, user models, retail models, interaction models, user context, device capacity and preferences, and providing the product interaction to a second user. The methods can involve performing verifications and scans (e.g., using sensors and cameras) relating to a user, candidate product and/or an environment, and receiving input date from the verifications and scans. The methods can involve triggering, activating, or presenting one or more product interactions over a time duration to provide discernible effects, including actuation of physical hardware components. The methods can involve providing an indicator of a product interaction with a representation associated with the video or image of a user with an authenticated branded product displayed. The methods can involve receiving from a second user one or more inputs, and generating and/or providing one or more product interaction. Accordingly, the methods involve computer hardware and physical equipment to perform measurements for the input data, and/or provide discernible output product interactions.

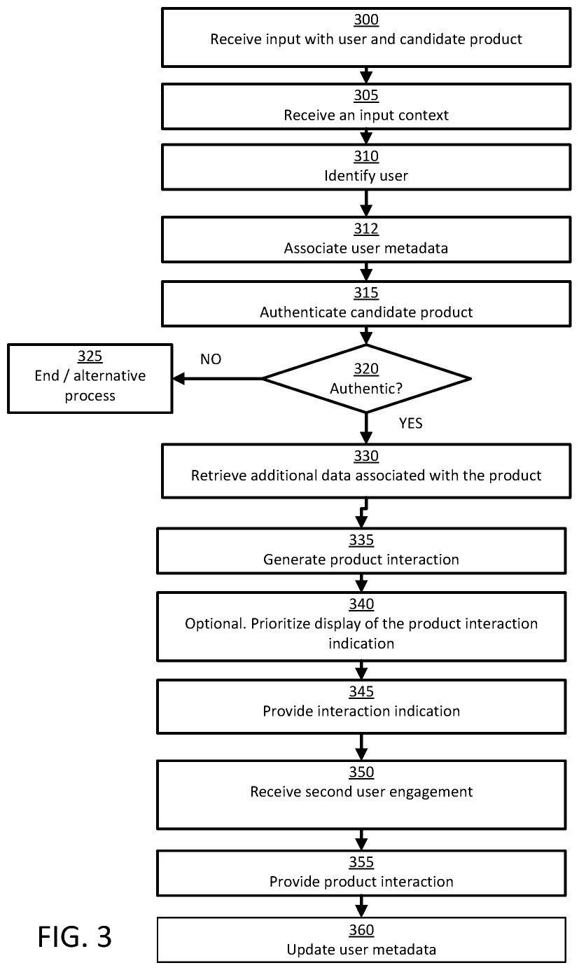

Methods, and aspects of methods are shown generally in FIGS. 3-11 which show diagrams of the steps that may be taken to provide and generate a product interaction based on an input depicting a first user and a candidate product. As the skilled person would recognize, the steps shown in FIGS. 3-11 are exemplary in nature, and the order of the steps may be changed, and steps may be omitted and/or added without departing from the scope of the disclosure. Methods can perform different combinations of operations described herein to provide or generate branded product interactions.

Turning to FIG. 3, in accordance with an embodiment, a method of generating a product interaction based on an input depicting a user and a candidate product is provided. The process may be initiated from a number of different contexts such as participating within a smart Mirror based activity (exercise class, training session, or concert), a virtual reality context, an online social media environment, a retail environment, and/or using a specific application for authenticating branded products and generating product interactions. The process may be initiated based on a user interaction, as part of a larger process, or as a default system behaviour. The method of FIG. 3 is applicable to a specific user, a community of users, a class instructor, an educator, an influencer, a simulated representation of an individual user, a simulated representation of a community of users, and the like.

This method is applicable to generating templates for product interactions, actual product interactions, and a combination of templates and product interactions. Product interactions are engagements with a specific branded product, or a specific substitute branded product that is associated with the initial branded product. In some embodiments, a substitute product may be selected that is appropriate given merchandise stock, size, regional, and color availability.

The product interaction provides a second user with one or more means of engaging with the first user's depicted branded product (or a substitute product). In some embodiments, more than one branded product is combined in a product interaction. In some embodiments, combining more than one branded product enables a second user to engage with the more than one branded product as a single collection, and for example purchase an outfit or add an outfit to a wishlist.

Example types of product interactions include adding the displayed branded product to a viewed product history, adding the displayed branded product to a customized storefront, adding identification values associated with the displayed branded product to a dashboard or trend analysis, adding identification values associated with the displayed branded product to an incentive system, displaying a closet tour associated with the branded product, displaying environmental and/or sustainability factors associated with a branded product, displaying a 360 degree view of the product, displaying an interactive simulation of the product, displaying a pop-up with additional product details related to the displayed authentic branded product, providing a link to purchase the displayed branded product, providing a link to purchase more than one authenticated branded product in combination (buy an outfit), providing a link to purchase the branded product in the second user's size, preferred color, preferred region, providing a link to receive a special offer related to the displayed branded product, displaying an interactive product site for the displayed branded product, providing a link to related products for the displayed branded product, providing a link to other products related to the user associated with the displayed branded product, providing a link to other products in the user associated with the displayed branded products closet, purchase history, interacted with items, liked items, reviewed items, wishlist items, combinations, or the like and combinations of such interactions. In some embodiments, the first user is able to access one or more versions of an associated branded product closet associated with the first user independently of the second user accessing the displayed branded products closet. In some embodiments, the closet is associated with a set of authenticated branded products, purchase history, interacted with items, liked items, reviewed items, wishlist items, combinations, or the like.

In some embodiments, the closet tour can involve use of a simulation environment representing a physical environment (e.g. its closet and garments), and a digital twin representing the user in the simulation environment. A digital twin maps physiological outputs related to the user and garments for the simulation environment. The simulation environment can generate simulation data relating to the digital twin to estimate or predict attributes of the garments and the user in a physical environment (e.g. its closet) with similarities to the simulation environment. The digital twin can be used to define personalization data relevant to a given user. The system 100 can train or update models using feedback data and output as a feedback loop for the digital twin and simulation environment, which can change the simulation for the digital twin. The closet tour can involve one or more personality components that can be based on personality factors that measure or estimate different aspects of a user's personality. A digital twin can have a visual representation in the simulation environment, such as an avatar.

As noted herein, the simulation environment (representing a physical environment) and digital twin (representing the user in the simulation environment) can apply to other example product interactions, such as a virtual change room and product demonstration.

The method in FIG. 3, involves evaluating whether a candidate product is authentic and then, in the case of an authentic branded product, providing a product interaction for that product. Receive input with user and candidate product 300 involves receiving an input depicting a first user and one or more candidate product. The input may be one or more of a still image, snapshot, moving image, real-time live stream, near real-time stream, recorded video stream, a virtual reality snapshot, a virtual reality stream, a recorded virtual reality stream, an augmented reality snapshot, an augmented reality stream, and/or a recorded augmented reality stream. In some embodiments, the input is received by user device 10 input 15. In some embodiments the input is previously recorded and stored on user device 10 memory 13 or elsewhere in the system. This input is then received and evaluated by product authenticator 40 on server 20. In some embodiments, product authenticator 40 may be provided on user device 10. Receive an input context 305 supplies additional information identifying the source of the input depicting a user with one or more candidate products. This contextual information may include user authentication details, device metadata, region, location, activity or class associated with the image or stream, file encryption standards, associated inventory ID tagging, lighting conditions, and the like.

Identify user 310 identifies the user. In one embodiment, identifying the user includes validating that the user identified in the input and the user associated with the providing of the input are the same person, share a physical resemblance, share an ID token, or the like. Associate user metadata associates additional information such as size, purchase history, navigation history, previous engagements with product interactions history, region, community membership, planned activity, activity history, and membership level. In some embodiments, identifying the user includes identifying the user as an anonymous user for whom no additional metadata is available.

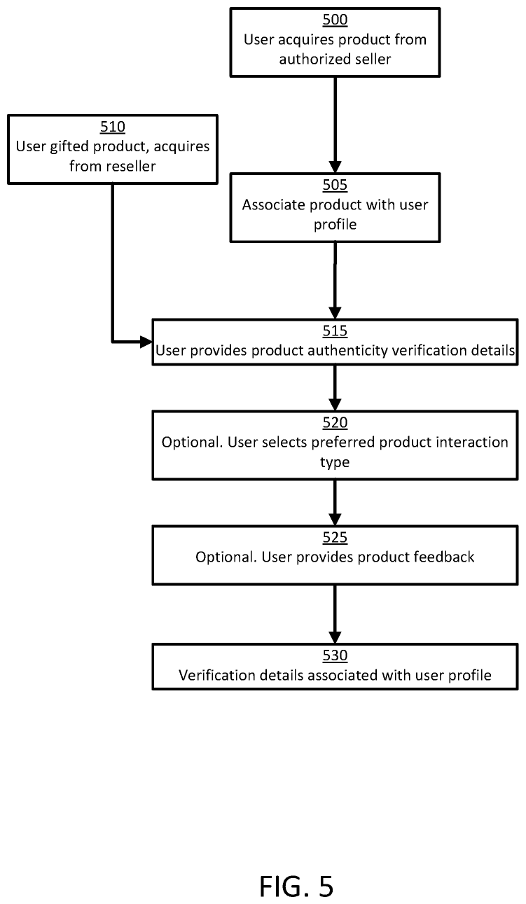

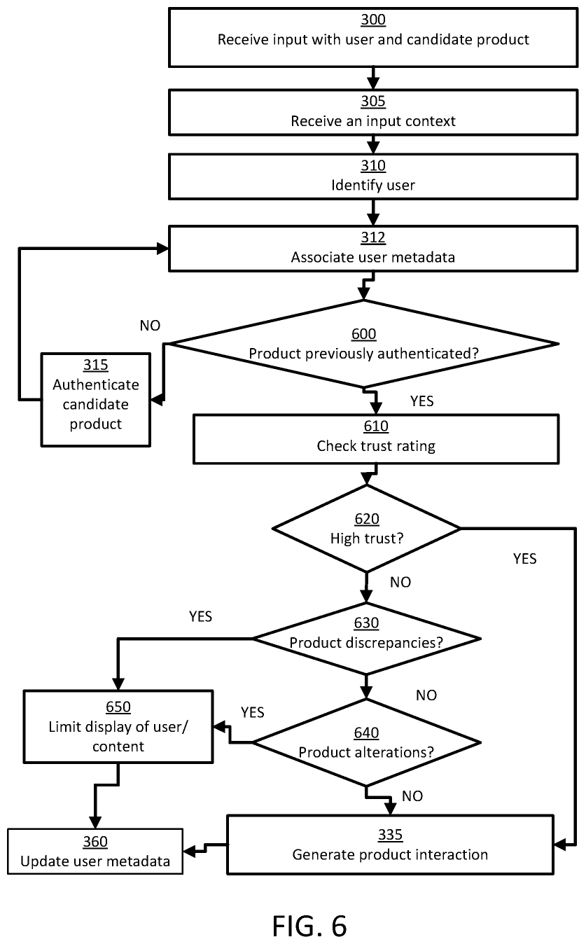

Authenticate candidate product may be performed by product authenticator 40 on server 20 to authenticate the product. Product authentication may include pre-authentication processes, see FIG. 5, and validation that the candidate product is not an altered version of a branded product, see FIG. 6. In some embodiments, one or more of the following authentication techniques are used detecting and reading one or more of a 1D (linear) barcode, 2D barcode, 3D barcode, watermark, microtext, hologram, forensic taggants, a sensor, circuit, printed code, UV code, infrared code, printed smart tag, smart token, RFID technology tag, BLE tag, and/or RTLS tag within, attached to, or on the candidate product. The system for generating a product interaction may include specialized sensors, cameras, readers, detection devices, and specialized executable instructions that are used in the methods associated with authenticating that the candidate displayed product is an authentic branded product.

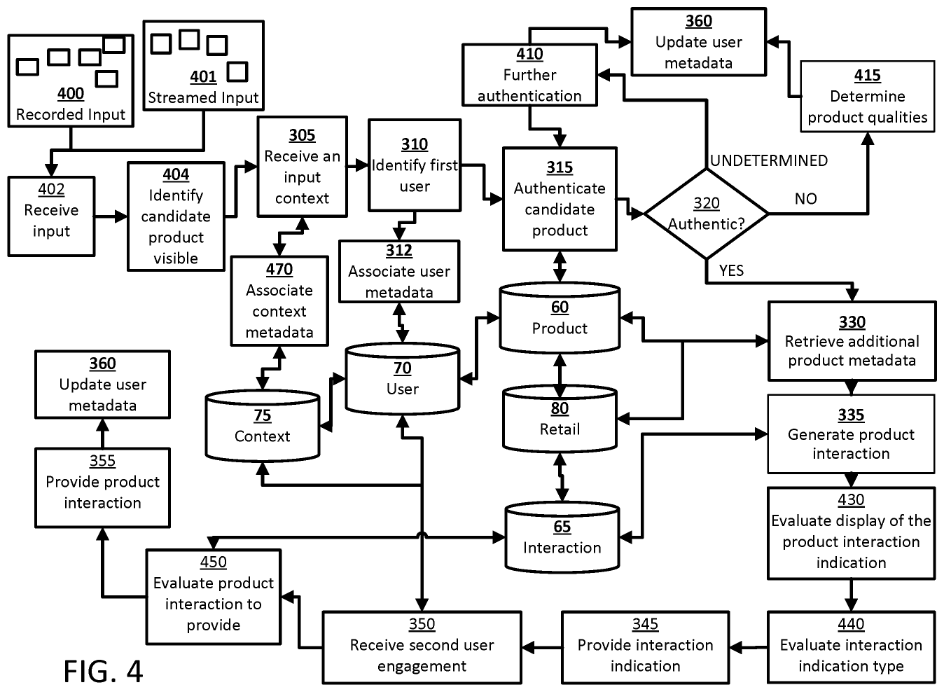

If the authentication fails to validate the candidate product, the process ends or alternative processes are initiated 325. FIG. 4 provides additional methods associated with a failed validation and/or inability to determine authenticity.

Retrieve additional data associated with the product 350 retrieves such aspects as additional data from product model 60 and/or retail model 80 to determine current product availability, regions in which the product is available, color, size, customizations related to the product, similar replacement products for regions, sizes, unavailable products and the like, promotions associated with the product, additional images, videos, information, demos, pricing, augmented reality experiences, virtual reality experiences, color swatches, and the like associated with the authentic branded product and/or its preferred substitute replacement products.

Generate product interaction 335 may be performed by product interaction generator 45 on server 20. In some embodiments generate product interaction 335 generates a template product interaction which can be used to customize, combine, and/or generate additional types of product interaction.

In some embodiments, prioritize display of the product interaction indication 340 provides instructions to the application providing a context for product interaction 6, such as in some embodiments application 18, online retail 85, or another application such as a streaming fitness activity experience, to determine whether an indicator will be added to the user image, stream, video containing the authenticated branded product, whether the user will be featured in a specific portion of the user interface, determined by such factors as the number of, availability of, relevance of, or current promotion of the authenticated branded products depicted. Other factors such as the user role, an instructor/leader role and/or function, user membership level, user community membership, user social network connections and the like may be factors in the selection process to determine prioritization associated with the display of a product interaction indicator. In some embodiments, a product interaction indicator is added whenever a product interaction is available.

Provide indication of product interaction available 345 includes a number of means such as featuring, profile circles, changes to translucency, indicators, highlighting, color coding identifiers, symbols, awards, location of a stream/image within a user interface, buttons, badges, shimmer effects, motion blurring, popping, changing a background, adding identification values associated with the displayed branded product to a dashboard or trend analysis.

Receive a second user engagement 350 indicates receiving input when a second user, noticing the indication of when a product interaction is available related to the first user image, video, stream or the like, engages with the first user content in such a way to indicate a desire to trigger the product interaction. In some embodiments, this engagement is selecting, clicking, or gesturing to the indicator displayed on the first user content with an authenticated branded object and a related product interaction. In other embodiments, eye tracking, voice commands, or opening a focus on the other user stream are means of engagement.

Provide the product interaction 355 provides the second user with the product interaction associated with their engagement. In some embodiments, the first user specifies preferences for the type, content, and features of the preferred product interaction to provide. In some embodiments, the type of product interaction provided is based on the second user context (exercise class, online retail, social media, virtual reality experience), the second user device capacities (audio, video, augmented reality, display size, haptic glove), preferences specified by the second user (add to my favorites, send me a weekly summary, add to cart if I don't own it yet), second user region, sizing, gendering, and the like used to determine availability of authenticated branded product for second user purchase preferences and propose alternative product interactions for products related to the authenticated branded product.

Update user metadata 360 updates the metadata associated with the first user and/or the second user related to the authenticating of a candidate product, generating, indication, engaging, and purchasing related to the product interaction.

FIG. 4 shows aspects of a method for generating and/or providing product interactions based on an input depicting a first user and a candidate product. Input values and data models of FIG. 4 and in embodiment examples are exemplary in nature, and the range of data provided, the order of the steps may be changed. Data elements and steps may be omitted and/or added without departing from the scope of the disclosure. Data models Context 75, User 70, Product 60, Retail 80, Interaction 65 are pre-populated and updated during aspects of the method of generating and/or providing product interactions. The FIG. 4 embodiment expands on processing operations in FIG. 3 showing additional data access, update, and exchange including data models product 60, interaction 65, user, 70, context 75, retail 80 intercommunicable and related to steps in methods to generate and provide a product interaction.

Recorded Input 400 and streamed input 401 are provided to receive input 402. Streamed input 401 comprises real time streamed video and snapshots, near real time streamed video and snapshots, real and near real time streamed video and snapshots from virtual reality, augmented reality, mixed reality. In some embodiments, recorded and streamed inputs are processed separately, and different authentication strategies are applied based on the whether the input is a previously recorded, streamed, image snapshot or video.

In one embodiment, a combination of recorded video input and streamed input are combined based on a rebroadcast on demand event with livestreaming participants. In one embodiment, the rebroadcast on demand event is a class, fitness activity, concert, training session, private workout, or the like. In some embodiments, multiple streams are simultaneously evaluated for methods related to this process and evaluate display of the product interaction indication 430 and evaluate interaction indication type 440 evaluate both livestreaming and recorded inputs with candidate products and/or authenticated branded products displayed.

Identify candidate product visible 404 identifies whether there is a candidate product visible. In one embodiment, the camera may be automatically adjusted, or the first user prompted to adjust the positions of one or more of the camera, the candidate product, or them self, first user, in order to facilitate the display and/or identification of the candidate product or user. Identifying candidate product visible may identify more than one candidate product. In some embodiments, receiving an input context 305 identifies the availability of input and output devices and related processing instructions for identify candidate product visible 404, identify first user 310, and authenticate candidate product 315.

Receiving an input context 305 identifies such factors as a user ID token, hardware capacities, software capacities, regions, encoding types, lighting, camera resolution, timestamps, exercise class context, workout context, membership level, user role, system hardware and other metadata associated with the recorded 440 and/or streamed 401 input. In some embodiments, the input context identifies one or more of whether the input is live or recorded, the time of the recording, the duration of the recording, the qualities of the activity depicted in the recording, and whether the user depicted is an instructor, educator, and/or influencer.

System associates context metadata 470. For example, system uses received input context 305 to associate context metadata 470. System updates context 70 in database with the associated context metadata 470.

Identify first user 310 identifies one or more of the users depicted in recorded input 400, streamed input 401, a user providing input 400 401, a user associated with the input context 305. In some embodiments, a user with an identity other than that of the first user depicted in input 400 401 may submit the input content 400 401, with a role providing permissions to act as an assistant, producer, or manager to the first user and provide the input content which depicts the first user. In some embodiments, metadata associated with the other user with a role providing permissions to submit input depicting another user is associated with the input content. In some embodiments, only metadata related to the first user depicted in the input is associated with the input content. In some embodiments, the first user that is depicted in the input content is the same user that submits the input content. The user model 70 may be updated with information related to the input received associated with the first user, other user with a role providing permissions to submit input, or both.

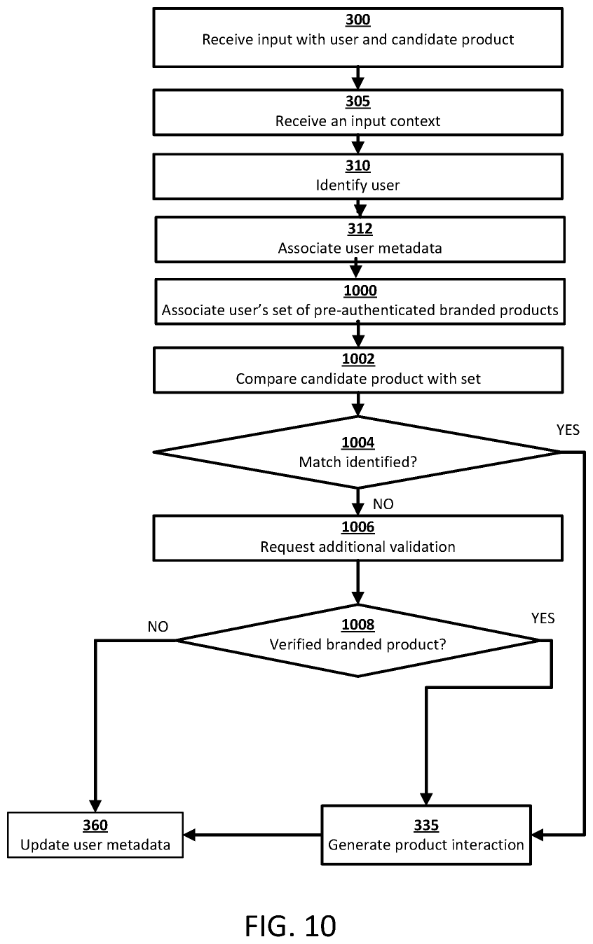

Authenticate candidate product 315 authenticates whether in fact the candidate product depicted in the input is an authentic branded product. In some embodiments, as described in relationship to FIG. 3, the method and system may make use of sensors, scannable codes, and the like. In some embodiments, the purchase history of the user is used as an aspect to validate whether or not a product is authentic. Other user characteristics, such a region, user role, activity, and gender may be used in candidate product validation. Pre-authentication methods such as those shown in FIG. 5 and FIG. 10 may be used as a factor in the candidate product authentication. The candidate product is authenticated against a populated product model 60.

In some embodiments, the means of authentication is different based on the product type. For example, t-shirts may have a printed 2D code and footwear may have an RFID device embedded.

In one embodiment, if the candidate product can be neither confirmed as an authentic branded product nor determined to be a copy, other brand, or fake product, further authentication 410 is triggered and the update user metadata updates user 70. Further authentication methods may include, requesting the first user submit candidate product images, scans, or other verification means.

When a product is determined not to be authentic, determine product qualities identifies aspects of the candidate product that has not been authenticated. This may include identify alternative competitor branding, copycat characteristics, and other factors associated with the candidate product. Update user metadata updates user 70 and may include changing the status or membership of a user.

Retrieve additional product metadata 330 retrieves additional metadata associated with the authenticated branded product. In some embodiments, a standard set of product metadata is retrieved to populate a product interaction template.

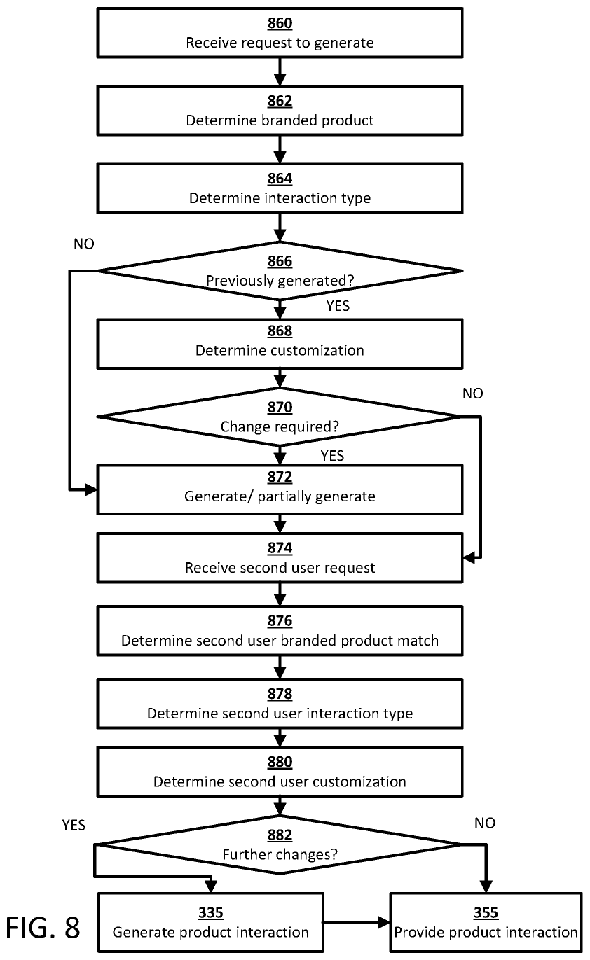

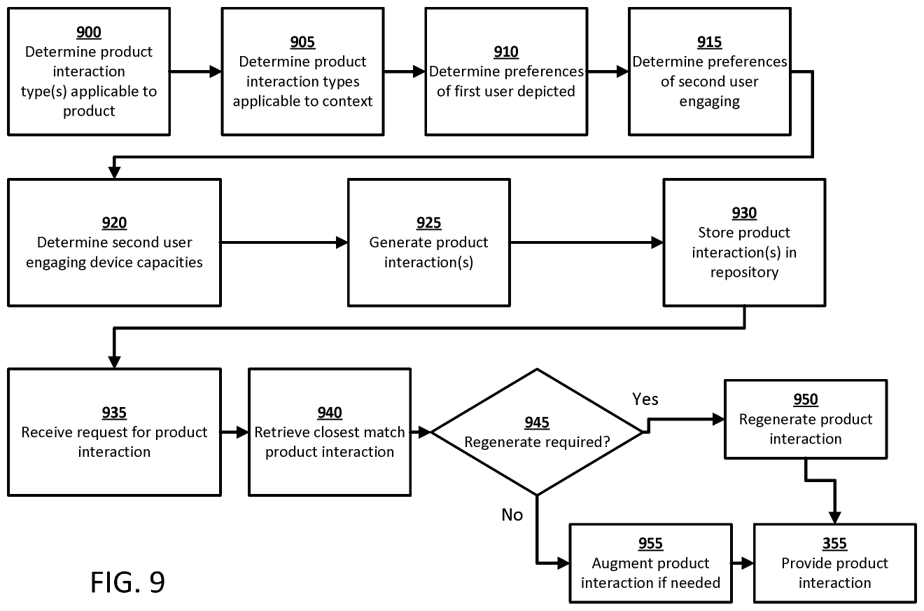

Generate product interaction 335 generates a product interaction for the displayed authenticated branded product or its substitute. See FIG. 8 and FIG. 9 for additional methods associated with generating, regenerating, and customizing a product interaction.

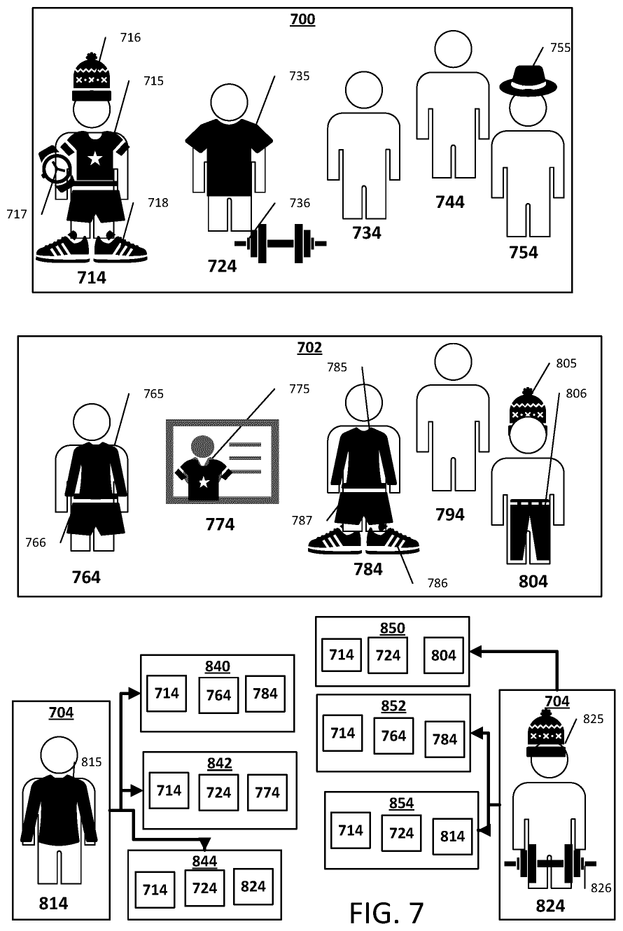

Evaluate display of product interaction indication 430 evaluates such factors as the current context, key product interactions, the number of product interactions that might be effectively displayed. In some embodiments, the prioritization is based on retail 80 including current promotions and offers, current season, region, overstock, availability, and the like. In some embodiments, the evaluation is informed by machine learning in the interaction model. In one embodiment, receive second user engagement 350, occurs prior to provide interaction indication 355, or reiteratively, and is an aspect which is evaluated when determining the which product interaction indications to display. For example, factors such as the user's friends, community affiliation, co-participants in previous activities, shared purchase history, similar authenticated branded products in the second user's input, similar candidate products that are not authentic branded products in the second user's input stream may be used to evaluate display of the product interaction indication 430, evaluate interaction indication type 440 including prioritization, location in the interface, means and style of providing the indication. See FIG. 7 for an illustration of multi-stream product interaction prioritization logic examples.

In some example embodiments, the system involves receiving input, for visual authentication, using lidar scanning. The system can use computer vision to receive input. Computer vision may be based on pixel to pixel comparison, color comparison, logo placement, design patterns on the surface, or embedded, such as QR codes and similar identification means. The system can use computer vision to extract data relating to the user or product. The system can also involve sensors that perform measurements for receiving input. For example, the sensors can perform measurements for receiving input for images or video that includes the user, the product and its environment. The hardware processor can receive input data from the verification and scans, and process the measurements for the input.

In some embodiments, there may be pre-authenticated branded products associated with a user profile (e.g. a labeled data set), and data associated with those products can be used for authentication. Example data includes version, season, year where logo placement and/or other product identification means may be different for different products. From a user profile, data such as purchase history, pre-authentication, location/region may be used to reduce the set of garments to be authenticated. For chips associated with or potentially applied in conjunction to computer vision authentication, RFID/UWB have greater range for sensor detection. There may be different types of product marking such as UV, InfraRed, internal light/energy reactive elements (similar to x-ray) printing on, embedding in, and or containing products. The system can use product marking to obtain or receive input. There are a number of candidates for product authentication and different combinations of data based on user profile and visual detection can be used.

In one embodiment, the system can detect the authenticated branded product displayed by a user (such as an instructor or leader) and send to a second user data or information about this outfit prior to a class so that the second user is able to purchase a matching outfit prior to the class. For example, this may be based on a rebroadcast of a class or a planned outfit (potentially pre-authenticated) for an upcoming live class.

Provide the interaction indication 345 displays one or more indications that a product interaction is available. In some embodiments, only streams, profiles, images, and the like with an associated product interaction are displayed and no further indication is added to the user interface. In one embodiment, the interaction indication type associated with provide interaction indication 345 may comprise one or more of a dashboard, count indicator, trend analysis, a combination of a dashboard and other interaction indications, a combination of a count indicator and other interaction indications, a combination of a trend analysis and other interaction indications, or the like. In some embodiments, provide interaction indication 345 may include providing a means to access an interaction experience such as displaying a QR code, printing a ticket, printing a membership token, displaying an access code and so on.

Receive a second user engagement 350 indicates receiving input when a second user, noticing a product interaction is available related to the first user image, video, stream or the like, engages with the first user content in such a way to indicate a desire to trigger the product interaction. In some embodiments, this engagement is selecting, clicking, or gesturing to an indicator displayed on the first user content with an authenticated branded object and a related product interaction. In other embodiments, eye tracking, voice commands, or opening a focus on the other user stream. In some embodiments, the second user engagement provides additional context and user metadata. In some embodiments, the system receives the second user metadata 70 and context 75 prior to receive second user engagement 350 as part of engaging with, logging into, or using a membership profile.

Evaluate product interaction to provide 450, evaluates the product interaction, and possible alternative product interactions, for the branded product based on the context, the second user context, and/or the second user metadata. In some embodiments, a user can select the type of product interaction they are provided. In some embodiments, provide product interaction 355 triggers a delayed process that for example may be provided when a user completes a workout, game, or other activity. In some embodiments, the product interaction is provided in a different context within the system, for example the second user may be engaged in a smart mirror workout activity and provide product interaction 355 may add a product to the second user's cart in an online retail environment. In some embodiments, the interaction model 65 is updated based on the product interaction provided, engagement with the product interaction, purchases resulting from the product interaction and the like.

As one familiar with the art will recognize, the method in FIG. 4 may make use of machine learning types based on one or more of a combination of unsupervised, supervised, and reinforcement learning. Such machine learning may be performed using processes and evaluation tools such as K-Means Clustering, Hierarchical Clustering, Anomaly Detection, Principal Component Analysis, Apriori Algorithm, Naïve Bayes Classifier, Decision Tree, Logistic Regression, Linear Regression, Regression Tree, K-Nearest Neighbour, AdaBoost, Markov Decision Processes, Linear Bellman Completeness, Policy Gradient, Asynchronous Advantage Actor-Critic (AC3), Trust Region Policy Optimization (TRPO), Proximal Policy Optimization (PPO), Deep Q Neural Network (DQN), C51, Distributional Reinforcement Learning with Quantile Regressions (QR-DQN), Hindsight Experience Replay (HER) and the like. In one embodiment, the machine learning is based on one or more of user feedback, user engagement, user purchases, product interaction engagement, product interaction feedback, product interaction engagement, purchases resulting from a product interaction, product interaction type feedback, product interaction type engagement, purchase resulting from a product interaction type.

Update user metadata 360 updates the user metadata. Throughout the process, one or more of the first user with an authenticated branded product, another user with permission to provide content depicting the first user, a first user with an undetermined candidate product, a first user with a not authentic candidate product, and the second user's metadata are updated.

In one embodiment, the input depicting a first user and one or more displayed candidate product is one or more of a still image, snapshot, moving image, real-time live stream, near real-time stream, recorded video stream, a virtual reality snapshot, a virtual reality stream, a recorded virtual reality stream, an augmented reality snapshot, an augmented reality stream, a recorded augmented reality stream uploaded to, hosted on, streamed by or the like a third-party platform and a plug-in provides a means of authenticating the candidate product and providing a product interaction indication 345 and/or product interaction 355. In some embodiments, a badge is a component in this process. In some embodiments, the first user is displaying a virtual version or depiction of a candidate product. In some embodiments, when the user is displaying a digital and/or virtual version or depiction of a candidate product, providing a product interaction indication 345 and/or product interaction 355 includes providing a product interaction with the digital and/or virtual version or depiction of an authenticated branded product, in some embodiments with the physical version of the authenticated branded product that the digital and/or virtual version or depiction represents, and is some embodiments a combination.

In some embodiments, the user device 10 capturing input 15, such as recorded input 400 and/or streamed input 401 input may be shared user device accessed by more than one user. For example, a moving or stationary camera controller device (video, single, multi-frame capture) in a public or private space, such as a trail, race start location, gym, yoga studio, bike route, water access point, or the like. A first user may perform a “snap and go” at the beginning, mid-way through, or end of an activity or a combination thereof. Additional metadata such as time stamps, velocity, movement type, biometrics, activity type, mood, gear associated with activity, ratings, may be captured and associated with recorded input 400 and/or streamed input 401, In some embodiments, a user may use a token or other identification means, separately or in combination with providing recorded input 400 and/or streamed input 401 to trigger engagement with the product interaction system. In some embodiments other means of authentication are used in conjunction with and/or independently of recorded input 400 and/or streamed input 401 to authenticate a candidate product.

In some embodiments, provide interaction indication is provided using a user's personal device such as a smart phone, smart watch, computer, tablet, or activity tracker, a stationary camera controller device (video, single, multi-frame capture) in a public or private space, or a combination. In some embodiments, the shared user device such as stationary camera controller device (video, single, multi-frame capture) in a public or private space integrates a output component such as a display screen. In some embodiments, a display screen provides a dashboard or trend summary of authenticated branded products, provide interaction indication 345 and/or provide product interaction 355 associated with receive input 402, receive input context 305, identify first user 310. In one embodiment, a summary indication of trending apparel associated with the “snap and go” device is displayed and an interaction means, such as a touch panel, is provided such that a second user may interact with a provided interaction indication 345 such as a trend number, and see additional product information and/or purchase a product either using the “snap and go device” or by associating an item displayed on the “snap and go” device with their user profile, wishlist, shopping cart, or the like. In some embodiments a token ID, an authenticated branded product, scannable membership card, or the like is used to provide context associated with a second user.

In some embodiments sensors or other means of authentication for one or more of a 1D (linear) barcode, 2D barcode, 3D barcode, watermark, microtext, hologram, forensic taggants, a sensor, circuit, printed code, UV code, infrared code, printed smart tag, smart token, RFID technology tag, BLE tag, and/or RTLS tag within, attached to, or on the candidate product are integrated or associated with user device 10.

In one embodiment, a second user may “unlock” and be provided with route, location, wishlist, closet, retail offer, or other information associated with a first user based on a shared authenticated branded product, authenticated brand product type, authenticated branded product activity category, authenticated branded object trend category, specialized team authenticated branded product, a combination, or the like. In some embodiments, a second user's option to “unlock” and be provided with indications and interaction experiences associated with a first user is also associated with a shared geo-location proximity either synchronously and/or asynchronously in time, a shared geo-location pattern or route either synchronously and/or asynchronously in time, shared demographic or user profile details such as membership level, gender, age range, activity profile, community affiliations, activity history, following a first user on social media, a retail platform, or the like, attending a event, competition, class, activity, education, game session associated with a first user, and the like.

In some embodiments, the shared user interactive device contains or is associated with an output device such as display output device, such as interactive touch screen, interactive billboard, audio or broadcast output, printer, 3D printer, token output device, ticket output device, previously manufactured object output mechanism, or the like. In some embodiments the output device is used to perform provide interaction indication 345 and provide product interaction 355. For example an indication, or product interaction may be depicted using a display output, a QR code for accessing a product interaction may be printed on paper or another medium, a ticket or token for attending a event, a event including a product interaction demo may be printed, a code or link to receive a retail offer may be displayed, printed, or the like.

FIG. 5 shows an example method associated with authenticating a candidate product, pre-authentication, and/or generating a product interaction. The method may be initiated when a user acquires a product. As shown in FIG. 5, the verification process may be different whether user acquires product from authorized seller 500 or user gifted product or acquires product from reseller 510. In some embodiments the user purchases the product from an authorized seller or reseller, or is gifted the product by a third party. In some embodiments, the user may be provided with the product by the authorized seller or reseller without making a purchase, for example as part of a closet and/or wardrobe provided to a guest, member, influencer, instructor, or athlete for promotional, reward, community building, or other purposes. When the user acquires the product from the authorized seller 500 at the point of sale, as part of the retail purchase, or as part of the provision of the product, automatically associating product with user profile may occur. This identification of the user and product acquired may be based on authentication within an online retail application, identifying cookies user in an online navigational history, user self-identification during an in-person retail experience, providing a name, phone number, membership ID, membership card, or other trackable means when making the purchase, user purchase history, user payment method identification, and the like.

In some embodiments, when associate product with the user profile 505 occurs, based on user role, user trust, product type, or other factors user provides product authenticity verification details 515 includes different verification methods than are required if associate product with user profile is not completed. For example, when a user is gifted product, acquires from reseller additional product scanning, entry of codes, images, or IDs within the product, may be required.

User provides product authenticity verification details 515 includes using one or more of camera, microphone, scanner, and other hardware sensor, text entry, to verify aspects of the product. In some embodiments the user may need to scan specific text, image, QR code, or the like using a camera or specialized scanner, and/or sensor. In some embodiments the verification means is one or more of embedded within the product, printed on a garment surface, embedded on a garment surface, embedded in a garment tag, printed on a garment tag, printed on a receipt, embedded in a receipt, printed on packaging (such as a bag, box, storage container) associated with the product, embedded in packaging (such as a bag, sleeve, envelope, box, storage container) associated with the product. In some embodiments, the user can select a preferred means of verification, and/or more than one means of verification are required.

As part of the method of FIG. 5, optionally a user selects preferred product type interaction. For example, a user may be associated with a specific activity type (running, yoga, tennis, etc.) and choose a product interaction type defined to provide a product interaction with information, media content, or features specific to that activity type. In some embodiments, interaction types for are designed for sharing in specific contexts such as social media, online platforms, streamed fitness activities, text messages, or the like. In some embodiments, interaction types may be associated with a user role, membership level, or activity status. For example, specific interaction types may be available to instructors of fitness classes. In some embodiments, the user's interaction type preferences are stored with other user data and applied and/or evaluated automatically when generating a product interaction associated with the user.

Optionally, a user provides product feedback 525 as part of the method. In some embodiments, user feedback is integrated within a product interaction. For example, a user rating, review, unboxing video, or the like may be available to the second user who experiences the product interaction. In some embodiments, the user rating determines whether a product interaction associated with the user is prioritized or provided. For example, a product interaction associated with a user's higher rated product may be displayed and/or have a higher priority for indication, and like and a product interaction associated with a user's lower rated product may not be displayed and/or have a lower priority for indication.

Verification details associated with user profile 530 may include codes and IDs associated with the verified products, preferred product interactions and/or interaction types, user product feedback, user engagement, user verification preferences. User model 70 may be updated. In some embodiments, additional models such as product 60, interaction 65, retail 80, context 75 may be updated. In some embodiments, a collection or closet of authenticated products is associated with user profile at 530. In some embodiments, the first user is able to access one or more version of an associated branded products closet associated with the first user independently of the second user accessing the displayed branded products closet. In some embodiments, the closet is associated with a set of authenticated branded products, purchase history, interacted with items, liked items, reviewed items, wishlist items, combinations, or the like.

FIG. 6 shows an aspect of a method associated with some embodiments for authenticating a candidate product, generating, and/or providing a product interaction. As will be appreciated, FIG. 6 provides an example, the processing instructions may be performed in other orders, simultaneously, adding, and/or omitting steps described.

Receive input with user and candidate product 300 initiates this aspect of the process. Receive an input context 305 provides contextual information concerning the user providing the input, the input format, hardware and software associated with the input and additional contextual data. In some embodiments, the input context also identifies whether there is problematic content within the input (such as additional individuals other than the user depicted who may not have consented to image broadcast/rights, minors, nudity, problematic images in the background, political images or slogans in the backgrounds, other explicit content) and in some embodiments, when a problematic context is identified the method is to identify user 310, limit display of user/content 650 and update user metadata 360 and data.

Identify user 310 identifies one or more of the user submitting the input, the user depicted in the input, and/or both the user submitting and depicted. In some embodiments, a user may be anonymous or depersonalized.

Associate user metadata 312 associates data and metadata in the system with the user. In some embodiments, the user is associated with one or more of roles, groups, communities, purchase histories, activity histories, user product pre-authorization of products, authorization to administer another user's inputs, trustworthiness, and/or membership.

Product previously authenticated 600 verifies whether the candidate product has previously been authenticated. In some embodiments, multiple candidate products within input with user and candidate product can be simultaneously evaluated and one product may be previously authenticated, and another product may not have been previously authenticated.

Check trust rating 610 checks the trust rating related to a user and/or a branded product. In some embodiments, certain user roles such as instructor, influencer, administrator, or educator are associated with a high degree of trust. In some embodiments, a user with one or more of limited user authentication, a mismatched product authentication history and product purchase history, a region with a problematic activity history, a group with a history of problematic activity history, a user device aspect associated with problematic activity history, and/or a history of attempted branded product deception is identified as not being a high trust user.

In some embodiments, a combination of role and user activity history, and/or purchase are used to determine a trust rating. In some embodiments, trust rating may be calculated based on a product or product type trust rating either independently or in conjunction with factors associated with the user. For example, a candidate product with a potential match for a branded product for which there are many knock-off copycat versions marketed by unaffiliated sellers and fewer embedded authentication means may be rated as a low trust product and/or product type.

When user and/or product trust is rated as high, generate product interaction 335 and update user metadata 360 and data may be executed without further validation of the image and/or video input. In some embodiments, reducing validation may be advantageous such as in the case of a trusted instructor who may integrate a number of branded products within a workout where a real-time and/or near real-time product interaction related to the branded products used by the instructor is useful to the second user engaging with the product interactions.

In other situations, additional validation that the candidate product is an actual match of a previously authenticated branded product may be advantageous. When No, high trust 620, an additional product discrepancies 630 verification is performed. For examples, discrepancies include potential look alike products, a product which is associated with pre-authentication for more than one user, a candidate product where details do not fully match the associated potential branded product (color, design, notions, decoration, pattern, fit and the like), a candidate product which is potentially intentionally visually obscured.

When No, product discrepancies 630, an additional product alterations 640 verification may be performed. Product alterations include such things as for example wearing/using a product in an unintended manner (for example an undergarment as a hat), adding obscenity, political statements, incorrect trademark identification to a product surface, an alteration (adding to, removing from, or altering, the product) such that the displayed candidate product is no longer is a meaningful match to the branded product when viewed by a second user.

In some embodiments, authentication of candidate products is incentivized by shared rewards. For example, if more than half of the fitness class are wearing a authenticated branded t-shirt, all participants in the class, those participants wearing an authenticated branded t-shirts, or those participants not wearing an authenticated branded t-shirt could receive a special offer, complimentary product, membership level, badge, or other reward. For example, if a thousand wearers of authenticated branded product authenticated their gear at a “snap and go” location on a running route, those wearers of authentication might have a badge, retail offer, specialized product interaction experience, coupon or other award associated with their user profile and/or account. In some embodiments, multiple categories of users are defined in relationship to multiple categories of displaying authenticated branded product, interaction with a product interaction indicator, engagement with a product interaction and are provided with customized interaction experiences, rewards, or the like associated with one or more of authenticating a candidate product, history of authenticating a candidate product, number of authenticated branded products, interaction with a product interaction indicator, history of interaction with a product interaction indicator, number of interactions with a product interaction indicator, engagement with a product interaction, history of engagement with a product interaction, number of engagements with a product interaction, or the like.

Turning to FIG. 7, some examples of prioritizing an indication related to a product interaction are provided. This example provides a simplified view of the indication processes, and it should be understood that there may be any number of broadcasts and rebroadcasts and that the number of participants may be in the hundreds, thousands, or more. In some embodiments, the instructor led first broadcast is based on a live in-person class with multiple participants. In some embodiments, the instructor first broadcast is pre-recorded prior to broadcast. Participant users may be participating in a previously recorded broadcast, where all or a portion of the content has been previously recorded, real-time or near-real time broadcasts, and the like.

In this example, there is a first broadcast 700 with instructor 714 providing a guided workout and participant users 724, 734, 744, and 754 performing the workout. Participants 724, 734, 744, and 754 may be represented by a stream of video, one or more images, and the like. As indicated in this example instructor 714 is displayed with (and/or wearing) a number of authenticated branded products, hat 716, shirt 715, device 717, and shoes 714. Participant user 724 and 754 are also displaying authenticated branded products. In this example, participant 724 wearing shirt 735 and displaying weights 736 in the background beside them. Participant 754 is displayed with hat 755. Other participants 734 and 744 do not have authenticated branded products displayed in their image/video stream.

There is a second broadcast 702, with participants 764 774 784 794 and 804 who are provided with the instructor 714 led exercise stream 700. In some embodiments, users may see only the feed from instructor 714 and in other embodiments users see past and/or current participant video streams, profiles, or the like. In second broadcast 702 users 764 774 784 and 804 are depicted as displaying an authenticated branded product. This shows an example of user 764 wearing a long sleeve shirt 765 and shorts 766. In the case of user 774, although they are depicted in a still image, shirt 775 is a branded authenticated product displayed in their profile image. Participant user 784 is depicted as being displayed with authenticated branded products long sleeve shirt 785, shorts 787, and shoes 784 and user 804 is depicted with authenticated branded products hat 805 and trouser 804.

In a third broadcast 704, users 814 and 824 are depicted where one user 814 has a displayed authenticated branded product long sleeve shirt 815 and another 824 has authenticated branded products hat 825 and smart weight 826. With regard to each participant user 814, 824 three different example logical processes to present product interaction indicators are shown. In each example, instructor 714 is prioritized as they are leading the instruction, although in other group activities, such as a streamed group run, an instructor image/video stream might not be prioritized. In some embodiments, prioritization is based on the indication type, size and/or location of a user associated with a product interaction. In some embodiments, a prioritized subset of the potential set of product interaction indication set is displayed and other product interaction indications are not displayed and/or require additional user engagement (scrolling, gestures, eye tracking input, selecting, and the like) to be displayed. The product interaction indicator may be implicit based on stream display, location of stream display on user device and/or the indicator may be an explicit visual, or other, means of indicating the availability of the product interaction associated with that participant user/instructor. Any number of indications may be provided. This example uses sets of three for discussion purposes, and there may be other variations and sets in different embodiments.

These logic systems are examples, and any number of sets of logic or combined sets of logic may be used and/or refined based on machine learning. For user 814 when set of indication set 840 is provided, in addition to instructor 714, participant users 764 and 784 are depicted who are wearing similar long sleeve shirts to user 814 shirt 815 to encourage user 814 to interact with authenticated branded products that are similar to their depicted branded product.

For user 814 when set of product interaction indication set 842 is provided, in addition to instructor 714, participant users 724 and 774 are displayed based on shared activity history, community membership, social media connections or the like. This selection is based on users 723 and 774 displaying a branded authenticated product but their pre-existing relationship with user 814 cause the display of the product interaction indicator to be prioritized rather than the specific branded product item or branded object type. When set of product interaction indication set 844 is provided participant users 714, 754, and 824 are displayed for user 814 based on a current promotion for headwear. This promotion is based on a product type, and the streams displayed to user 814 are logically selected based on maximizing exposure to headwear. In some embodiments, logic systems prioritize community and/or personal connections, such that set of product interaction indication set prioritizes, for the second user, users with social media connections or shared social media connections, shared or similar activity participation history, previous engagement on a shared retail, community, or wellness platform, shared or similar scheduled fitness class participation, shared or similar activity communities, shared or similar regional communities, shared or similar organization communities, shared or similar participation in an in-person experience, and the like.

A user who is not displaying one or more authenticated product, as should be evident, may also be provided with indications related to the availability of product interactions. Logic for determining the display of product interaction indictors for a user who is not displaying an authenticated branded product may be based on factors such as user region, product availability, purchase history, past activity, current activity, previous engagement with product interactions and the like.

For user 824 three additional example product interaction indications logic sets are displayed. For user 824 when set of indication set 850 is provided, in addition to instructor 714, participant users 724 and 804 are shown with an indicator of the product interaction availability. In each of these cases, the 724 and 804 have one authenticated branded product that matches or is similar to an authenticated branded product displayed with 824 and one authenticated branded product that is different. For example, 724 has a similar weight 736 to 824 weight 826 and a shirt 735 that is different, and 804 has a matching or similar hat 805 to 824 hat 825 and trousers 806 which are unique. For user 824 when set of indication set 852 is provided, in addition to instructor 714, participant users 764 and 784 are shown with an indicator of the product interaction availability user 824 has indications of the product interactions that display the most complete outfits of authenticated branded products. For user 824 when set of indication set 854 is provided, in addition to instructor 714, participant users 724 and 814 are shown with an indicator of the product interaction availability user 824 has indications of the product interactions that display the greatest variety of product offerings of a product type shirts. The product type may be selected based on whether it lends itself to display as a branded authenticated product, purchase history, navigational history, product interaction purchases based on previous product interaction engagements, sharing history related to products and/or product interactions, whether the user has pre-authenticated a product of the type, and the like.

In some embodiments, the display of authenticated branded product interaction indicators is based on data and metadata such as purchase history, retail navigational history, wishlist history, and the like for the user to whom the product interaction indicator is being provided. In some embodiments, the display of authenticated branded product interaction indicators prioritizes whether the branded product interaction prioritizes a branded product with availability, availability in a specific user's region, size, gender, preferred color. In some embodiments, prioritization is based on promotions, new product offerings, seasons, and like.

Referring to FIG. 8, an additional method related to an aspect of generating and providing a product interaction is shown. In some embodiments, product interaction methods include one or more of customizing a product interaction, generating a product interaction template, partially regenerating a product interaction, augmenting a fully or partially generated product interaction with custom content from a first user, customizing a product interaction based on aspects associated with a second user, storing product interactions in a repository, storing product interaction templates in a repository, storing previously generated components of a product interaction in a repository, storing media associated with a product interaction in a repository, storing personalization templates, content, and or components in a repository, and/or storing customization templates, content, and or components in a repository. In some embodiments, some product interactions are generated with multiple components that combine to form the product interaction. For example, a product details page might be generated to include customization based on the identity of a second user, a demo video from a first user, a region-specific product information page, an integrated populated cart component from online retail. In some embodiments. In some embodiments, there is a template for a composite product interaction and components within a composite product interaction may be stored in a repository individually, in combination, or both.

Receive a request to generate product interaction 860 initiates the process. In some embodiments the request is triggered by verifying that a received input depicting a first user and a displayed candidate product includes an authentic branded product. Determine branded product 862 retrieves additional information about the product and evaluates aspects of the branded product. For example, inventory, availability, gender, sizing, style, region, season, product type, and/or promotions, and the like, may be evaluated with when determining the branded product that will be provided in a product interaction.

In some embodiments, when a first user is displaying more than one branded product, the branded products may be combined into an outfit type product that combines the branded products into a group of products that a second user may interact with in combination through a product interaction. In some embodiments, if the displayed branded product is not the current product version, not available in a region, size, gender, or color, a substitute branded product may be used to generate a product interaction.

Determine interaction type 864 determines the type of product interaction that will be generated. In some embodiments one or more of a template, standard set of product interactions, product or product type specific product interaction, system context product interaction type, and/or activity context product interaction type is determined. Product interaction types may include a composite of interactions such that, for example, a single product interaction generates executable instructions to provide a second user an interactive product display, a modification to a wishlist, and a related promotional email. In some embodiments, the first user specifies a preferred product interaction type and/or aspects of a product interaction type.

Previously generated 866, verifies if a product interaction has been previously generated for the branded product and/or interaction type identified. If no product interaction has been generated for the branded product and/or interaction type, generate or partially generate 872 generates a product interaction. If a yes, a product interaction for the branded product and/or interaction type identified has been generated, determine customization checks whether there is customization required. For example, customization may be required for such aspects as branded product color, size, length, style, model, season, gender, regional language, updated retail pricing, specifications, offers, first user media content provided associated with the branded product, first user rating of the branded product, first user demo of the branded product, first user review of the branded product, and the like. If a change to the product interaction is required, product interaction generate/partially generate 872 incorporates such changes.

Receive second user request 874, occurs when a second user, engages with the first user content with an associated product interaction. Determined second user branded product match 876 determines whether the branded product provided in the product interaction is appropriate for the second user. In one embodiment, a substitute branded product will be provided when the branded product associated with the product interaction is not available for purchase by the second user based on availability, region, color size, gender and the like. Determine second user interaction type 878 determines whether based on one or more of the second user hardware, activity context, preferences, region, language, activity history, and/or engagement history, one or more interaction type are required.

Determine second user customization 880 evaluates whether user specific customization based on one or more of name, age, aesthetic preferences, activity history, activity preferences, community affiliation, region, language, and/or membership level is required. If further changes 882 are needed, generate product interaction 335 either fully or partially regenerates one or more product interaction, and provides it. If no changes, provide product interaction 355. Providing a product interaction may generate executable code that generates a product interaction at a later time. For example, on a smart mirror a product interaction may be displayed in a cool down period after a workout has been completed.

Turning to FIG. 9, additional aspects of a method related to generating and providing a product interaction are shown. Prior to the operations shown in FIG. 9, one or more authentic branded product is identified in an input depicting a first user and one or more candidate product. Determine product interaction type(s) applicable to product 900 evaluates which interaction types are specifically applicable to the one or more branded products identified. In some embodiments, when multiple authentic branded products are displayed one or more of the following occurs, a product interaction is generated for each individual branded product, a product interaction is generated for a preferred product, a product interaction is generated for the composite outfit, a combination. Some product interaction types are applicable to all or most products, such as adding the product to a wishlist. Other product interactions contain content that is applicable to specific product types, or products, based on the specific characteristics of the product or product type. For example, the product interaction for a smart weight might include providing a second user with a list of their current class activities that include exercises where they could add a smart weight, a product interaction for a jacket might include a simulated experience where a user interacted with the fabric, was able to simulate rain on the jacket, and take a selfie of herself in a virtual representation of the jacket. Product interaction types may be specialized and reflect that users prefer to interact with different products, and different product types, in different ways based on different key aspects, activities, and features associated with a product.

Determine product interaction types applicable to context 905 evaluates the context associated with the user, the user's device capacities, the user's region, the user's current activity, and the like. In some embodiments, the first user and second user have a shared activity context such as streamed exercise activity, class, or concert that is a factor in determining the type of product interaction that is applicable.

Determine preferences of first user depicted 910. In some embodiments, the first user is an instructor, influencer, or athlete and the product interaction type is associated one or more of first user activities, first user custom content, first user associated social media platform content, first user specific promotions, first user specific exercises, instruction, or demonstration, and the like.

Determine preference of second user engaging 915 for example includes such factors as user accessibility requirements, region, language, preferred retail region, size, gender, aesthetic, activity, activity history, membership, purchase history, community affiliation. In some embodiments, the second user is able to explicitly specify the type (or types) of product interactions they want to receive. In some embodiments, data and metadata associated with a second user is received after the product interaction has been generated.

Determine second user engaging device capacities 920 includes evaluating device capacity in terms of screen size, resolution, graphics card, audio capacities, input devices, output devices, and the like. For example, the user device capacity for video game-type interactive content, virtual reality, augmented reality, and mixed reality may be factors to determine the type of product interaction to provide to the second user. A first user device may have different capacities than the second user device, for example a first user device may be a smartphone and a second user device may be a virtual reality connected environment, and the product interaction provided to the second user device may be provided with a product interaction that the first user device does not have the capacity to display, and similarly, the reverse may be the case with first user device and second user device.

Generate product interaction(s) 925 generates one or more product interaction. In some embodiments, these interactions may be one or more of a template, partially generated product interaction, standalone executable product interaction, and/or a customized product retail page. In some embodiments, store interaction(s) in repository 930 stores these product interactions within a repository such as interaction repository 68.

Receive request for product interaction 935 may specify such aspects as context, first user of the displayed authentic branded product, second user engaging, second user device capacity.

Receive closest match product interaction 940 retrieves the closest matching template or product interaction from the repository or memory. Regenerate required? 945 evaluates whether the product interaction retrieved can be provided without further regeneration. For example, in some embodiments, a product integration is regenerated for specific regions, gender designation, community affiliations, user memberships, user contexts and the like. In some embodiments, a timestamp associated with the product interaction is used to evaluate the freshness of the data associated with the product interaction and trigger a regeneration based on a set logic. If the product interaction requires regeneration in part or completely, regenerated product interaction 950 occurs prior to provide product interaction 355. In some cases, when No, a regenerate is not required, augment product interaction if needed 955 may apply customizations and updates. In some embodiments, such aspects as second user name, personalization, second user retail history, region specific retail links, and the like are added without regenerating the product interaction. Provide product interaction 355 provides the product interaction to the second user.

Turning to FIG. 10, an aspect of an embodiment associated with authenticating a candidate product, generating a product interaction, and/or providing a product interaction is described. This aspect may be integrated in methods such as those shown in FIG. 3 and FIG. 4. The method is initiated when the system and/or executable instructions associated with the system for generating and providing a product interaction receives an input with a candidate product 300. The system receives an input context 305 associated with the input depicting a first user and one or more candidate product. This context may include information such as user device, user device capacity, user device type, user activity, user activity history, user region, user login, user type, and other associated data. In some embodiments, a user may provide context information indicating that they are displaying a branded product for authentication. In some embodiments, where a user identifies there is a displayed branded product, they indicate the type of product (shirt, leggings, shoes, etc.).

Identify user 310 identifies one or more of the user depicted in the input, the user submitting the input, and/or the user both depicted in and submitting the input. In some embodiments, a user may be identified as anonymous and/or a depersonalized member of a group or community.

Associate user metadata 312 associates relevant data and metadata with the user identified during user identification processes 310. The user may be associated with one or more of a role, a community, a group, a trust rating, a purchase history, a product reward history, an authenticated product history, a set of pre-authenticated products, a region, a size, a membership level, and/or an activity history.

Associate user's set of pre-authenticated branded products 1000 associates products that the user has pre-authenticated with the user. In some embodiments, the entire set of pre-authenticated products is provided and in some embodiments a subset of pre-authenticated is provided. For example, in some embodiments one or more, or a combination, of most often worn, favorite, product of a specific type, and/or most recently purchased products are included within an initial subset of pre-authenticated products provided to the system for candidate product authentication and if a match is not identified, one or more additional items are provided for validation in an additional subset of pre-authenticated products.

Compare candidate product with set 1002 may include making a visual comparison using a camera device, scanning an image, code, or sensor, the use of sensor readers, or the use of additional verification hardware or computer executable software instructions.

If yes, there is a match identified 1004, the method continues to generate product interaction 335 and update user metadata 360 and data. If no, there is not a match identified 1004 the system will request additional validation 1006. In some embodiments, requesting additional validation triggers automated backend processes that adjust lighting, camera angle, request additional subsets of pre-authenticated products associated with the user, activate an alternative sensor, reader, or other hardware, and the like without requiring a user action. In some embodiments, requesting additional validation 1006 requires the user to complete an action such as input information, move their body or candidate product position, provide additional scans, provide product authenticity verification details, complete an attestation, activate additional hardware, adjust lighting, and the like. In some embodiments, request additional validation triggers both automated backend actions and requests for user actions.

If yes, the candidate product is a verified branded product 1008 the method continues to generate product interaction 335 and update user metadata 360 and data. If no, there is not a match identified 1008 the system will update user metadata 360 and data and will not generate a product interaction.

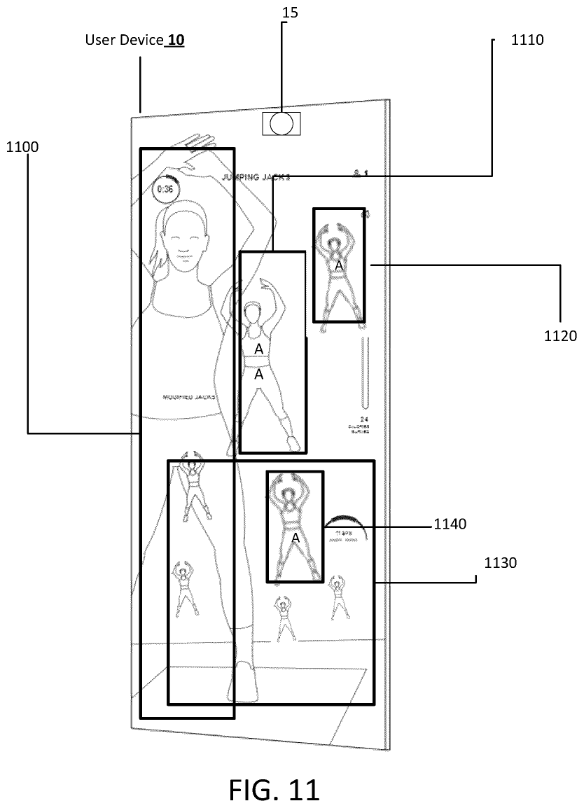

FIGS. 11-16 illustrate examples of aspects of embodiments for generating and providing product interactions based on receiving input depicting a first user and a candidate product. These are example embodiments, and do not describe the entire scope of all aspects. Other aspects, features and advantages will be apparent to those of ordinary skill in the art upon review of the following description of specific example embodiments.

In some embodiments an interface (e.g., application 15 of user device 10, web app 38 of server 20) provides an authenticated branded product interaction. In some embodiments, the product interaction is provided through a connected device, or smart device. In some embodiments, the authenticated branded product interaction, and/or an indication of the authenticated branded product interaction, is provided within the context of an exercise environment, exercise class, meditation class, guided workout, guided meditation, or the like, by adjusting the profile images, streams, screen position, providing additional color, symbol, video or other indicators. For example, the visualization can be updated or change to highlight aspects of the product or including overlays relating to the product. In some embodiments, a provided product interaction and indicator are displayed on the same user device and in some embodiments they are not.

In one embodiment, pre-authenticating a candidate product includes “offline” data about authentication and data entry that is collected manually, that is scanned by an employee in a retail environment, by a device that is not connected to the system, or through images, and the like. In one embodiment, participation in an in-person class, retail experience, or event, may be a factor in authenticating a candidate product.

In one embodiment, the manually collected data is related to an individual; in one embodiment to a group of individuals; in one embodiment to a combination of individuals and groups. This data may be manually entered through a text upload, an application, a voice prompt chat, scanned as an image, and the like. This data is received into the system 100.

In one embodiment, the authenticated branded product interaction is provided as human-readable instructions and/or guidance applicable to a real-world 3D context. In one embodiment, the instructions are provided to a coach, educator, retail assistant, leader, teacher, performer, or instructor in a format that enable that individual to communicate the instructions to another individual in-person and/or through a live voice and/or video chat. The branded product interaction may be provided by one or more of a web application, an application installed on a user device, a smart mirror device, a connected audio/music system, a connected exercise mat, a virtual reality headset, an augmented reality headset, a metaverse headset, a haptic glove, a game controller, a haptic garment, a retail application, a coaching application, a fitness class or studio application, a meditation application, a retail application, an email system application, a text message system application, a chat system application, and/or a notification system application. Authenticated branded product interactions may be provided in a “real-life” 3D reality environment, augmented reality environment, simulated reality environment, virtual reality environment, a game environment, a metaverse environment.

In some embodiments, a partner first user wearing pre-authenticated branded products leads a fitness, meditation, music concert, performance, educational, or wellness activity. In one embodiment, the partner first user is provided with a closet and/or wardrobe of pre-authenticated branded physical products for use/display when providing images and/or video within the system.

In some embodiments, the authenticated branded product interaction system is integrated within a retail system or social media platform. In some embodiments, an application is provided to authenticate one or more branded product and share images and/or video that contain the one or more branded product. In one embodiment, this is integrated within a product review in a retail system.

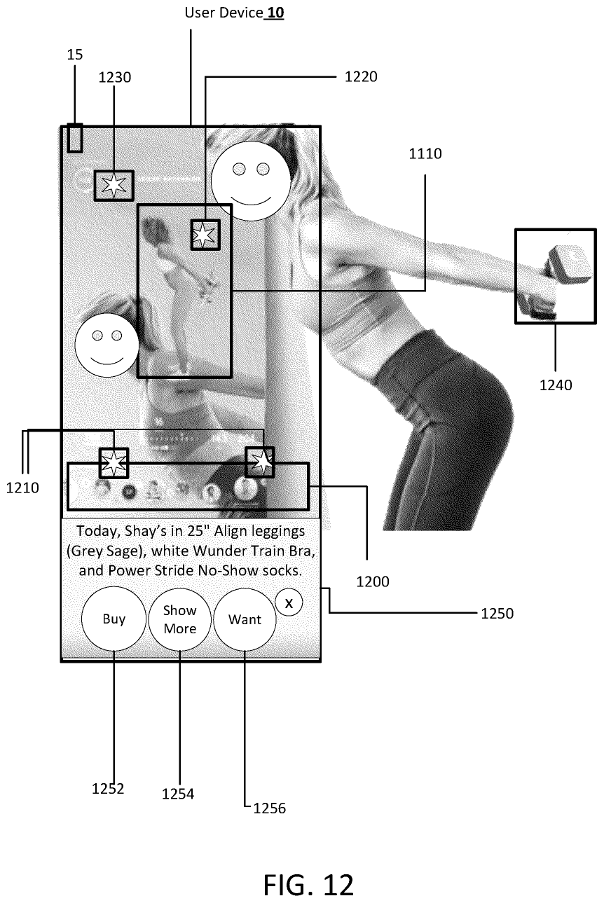

FIG. 11 shows an example embodiment in which the placement of video during a fitness activity indicates the presence of an authenticated branded product related to one or more first user, and the availability of a product interaction, for one or more second user. In some embodiments, (as shown in FIG. 12) additional indications may be added to identify the second user is viewing an authenticated branded product and may engage with a product interaction related to the branded product. For example, an icon or visual effect may be shown on the authenticated branded products identified with an A in this figure, or the screen position of the video stream may indicate authenticated branded products. In FIG. 11, we see the reflection 1100 in user device 10, shown as a smart mirror device, with input camera 15. Instructor video 1110 is presented at a scale and position to facilitate the second user following the instructor. In some embodiments, an instructor user is always wearing authenticated branded products as indicated with the A symbol. In some embodiments, a featured first user 1120 with authenticated branded products is shown in the upper portion of the screen behind the instructor or at a larger scale (or with another indicator) within a group of participants such as FIG. 1140 within group 1130.

The second user is able to select a product interaction related to one of the first users with a displayed authenticated branded product. Selecting a product interaction may be based on any number of means such as a voice command, gesture, touching a screen, eye position or commands, clicking, using an input device or controller in a device, or the like.

Selecting a product interaction results in one or more product interactions associated with the first user with a displayed authenticated branded product being provided to the second user. The product interaction may be provided immediately, such as displaying an information and/or purchase page, or later such as when the second user has completed a workout, or the next time the second user accesses an online retail site, application, or the like. In some embodiments, the context in which the second user engages with the indication, image, and/or stream associated with the product interaction is a factor in determining when, where, and how the product interaction is offered. In some embodiments, a single branded product interaction for an “outfit”, or set of branded displayed products, may be provided.

Turning to FIG. 12, an alternative example interface related to providing and generating product interactions for an authenticated branded product is shown. As shown in this figure, smart mirror user device 10 with input camera 15 may display a product interaction 1250. In this example, product interaction 1250 is displayed for instructor 1110 in the lower portion of the user device 10 screen 17 and indicators 1210, 1220 and 1230 are associated with user's depictions displaying authenticated branded products.

In this example, indicator 1230 is used to indicate to our user, Alice for the purposes of this example, that she is displayed with one or more authenticated branded products. Such an indication may be provided as a badge, color indicator, prioritization/screen position of a stream or profile image for second users, visual effect, adding identification values associated with the displayed branded product to a dashboard or trend analysis or the like. In some embodiments, a user may see an indication in their user interface that their image includes an authenticated branded product, and this image may not be displayed to a second user. For example, the authenticated branded product may not be available in the second user's region, the first user may have privacy settings enabled, or other first user indicators may be prioritized based on the system logic. In some embodiments, there are indications and/or badges, that are related to a first user having authenticated branded products that are not associated with a branded product interaction.

In some embodiments when profile images and/or videos 1200 are augmented with indicator 1210 of an authenticated branded product and product interaction, the second user is able to select the profile picture and/or mini, cropped video stream to view a video stream or image in a larger/different format, showing more detail, more of the first user's body and/or space, or the like. In some embodiments, the authenticated branded product may only be visible in the larger/different format image or video stream depicting the first user and the branded product and not in the profile picture, and/or mini, cropped video stream. An example of this includes when the authenticated branded product is footwear which may only be visible in a full-length video of the first user.

In this example, Alice is interested in what her instructor Shay is wearing and has selected that product interaction. In this example, Alice selected the product interaction by using eye tracking and staring at the indicator for the product interaction. This option may be configured based on Alice's preferences, the context of an exercise class (and the type of exercise class), and/or default settings. In some embodiments, there are more than one methods available for the second user to select and engage with a product interaction. In some embodiments, connected devices, such as hand weights 1240 may be used to engage with an indication of an authenticated branded product interaction and/or a branded product interaction.

In some embodiments, the second user's specific interaction with an indication that a branded product interaction is available may trigger different branded product interaction behaviour. For example, by engaging with the indicator through eye tracking and/or a nod, the second user triggers generating a branded product interaction that displays product information, and by making a point and snap gestures the second user triggers generating a purchase now in my size branded product interaction, while pointing and touching hands together triggers generating a branded product interaction that emails the second user promotions associated with the branded product. Similarly, different voice commands related to a displayed branded product indicator could trigger generating different branded product interactions. In some embodiments, a product interaction type selection menu is associated with a branded product indicator.

In the product interaction 1250, further information about instructor Shay's outfit is displayed and additional interactions such as Buy 1252, Show More 1254, and Want 1256 (wishlist) are provided. As will be appreciated, any number of product interactions may be made available within and from this first product interaction such as a demo, review, simulation experience, emailing or texting more information, signing up for an offer, opening a chat to learn more about the product, an additional exercise, and the like.

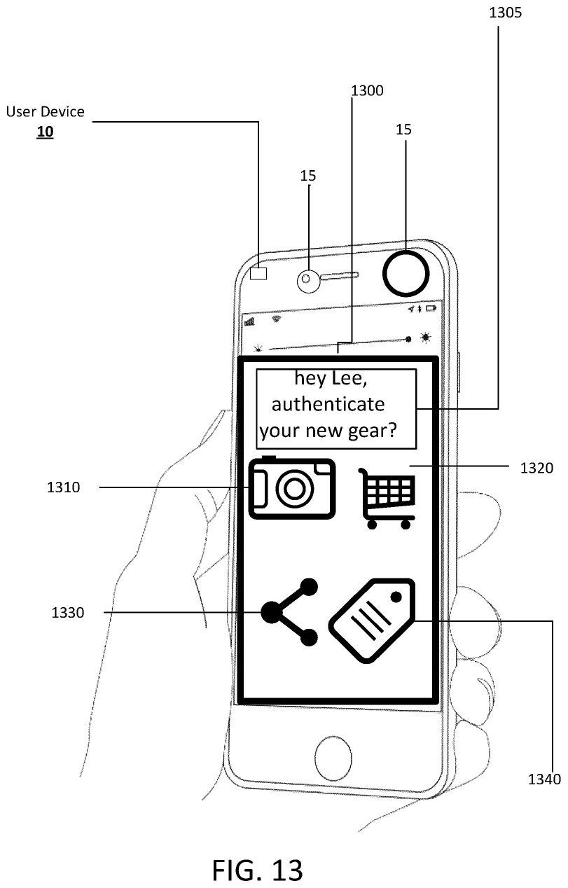

FIG. 13 provides an example user interface associated with generating and providing authenticated branded product interactions. This authentication may be part of another activity, such as an exercise class warm up or cool down, creating an online retail product review, and/or may be performed on its own. In some embodiments, a user pre-authenticates one or more candidate displayed products prior to engaging in a group activity in order to facilitate a quick branded product authentication process and/or ensure that they are provided with an authenticated branded product badge, award, or indicator. In some embodiments, a type of indicator, status, membership, and/or badge is provided to a user with one or more authenticated branded products associated with their user profile.

This authentication functionality may be provided on a number of different types of user devices and applications, and FIG. 13 provides an example of one of many possible ways of providing this functionality. In this example, user device 10 is of the type, smart phone, and is shown with multiple input devices 15 providing a microphone and camera inputs. Application 1300 provides the user, in this example Lee, with options for authenticating his candidate products to verify that they are authenticated branded products.

In some embodiments, as shown, there are more than one validation options which may each include multiple techniques. In some embodiments the user, Lee, is offered different methods for authenticating a candidate. For example, in FIG. 13 user interface, under the personalization message 1300, Lee is presented with three authentication options a camera 1310 for an image/video based means of candidate product verification, a shopping cart 1320 for a purchase history based means of candidate product verification, a tag 1340 for a sensor/ID tag means of authentication. In some embodiments, a single authentication method process is provided.

In some embodiments, products are authenticated as part of a process such as product purchase, earning member points, posting an online review, creating a membership profile, signing into an activity or class, logging into a system.

In this example, when Lee selects the camera 1310 option for authenticating his candidate product, he is provided with instructions on specific product details to photograph or video in order to establish the product characteristics and authenticity. These characteristics may be embedded within the product, printed on the product, embedded in a product tag, printed on a product tag, embedded in a receipt, printed on a receipt, and the like. The verification process may be different or the same for various products, and/or product types. In some embodiments, photograph and/or video authentication includes providing images associated with one or more of a 1D (linear), 2D, or 3D barcode, watermark, microtext, hologram, forensic printed code, UV code or infrared code, garment detail, hidden image or code, garment stitching, label, tag, or the like.

For example, in this embodiment, when Lee selects the camera to authenticate his new shirt, he is instructed to photograph a label printed on the shirt, a stitch detail from the hem, and the entire shirt from a specific angle to verify its authenticity. In some embodiments, a single verification image is used.

In this example, when Lee selects the shopping cart 1320 option for authenticating his candidate product, he is provided with a method of validating the garment using his purchase history. In some embodiments, Lee will be asked to select an item from his personal purchase history and enter a code that is printed on the garment. In some embodiments, when a user selects a product for verification from their personal purchase (or gift) history, no further verification details are entered. In some embodiments, different levels of verification are required depending on a user's role, community membership, membership level, and the like. In some embodiments, different levels or methods of verification are associated with different products, product types, or product costs.

In this example, when Lee selects the tag 1340 option for authenticating his candidate product, by scanning he is provided with instructions for discovering, identifying, and or scanning one or more of a printed smart tag, smart token, RFID technology tag, BLE tag, and/or RTLS tag within, attached to, or on the candidate product. In some embodiments, specialized scanners are attached to or embedded within user device 10. For example, when Lee selects the tag 1340 option for authenticating his candidate product, he is instructed to position the footwear branded product proximate to his user device and the application 1300 uses Bluetooth (for example) to connect with the sensor in his shoes. Lee may also be asked to take a picture of the shoes, to verify that the sensor has not been removed and placed in another product. In some embodiments, a combination of two or more of images, purchase history, and scannable tags are used.

In some embodiments, a branded product authentication kiosk is provided to users at an in-person retail location which provides additional scanners and means of verification to ascertain whether a candidate product is an authentic branded product. In some embodiments, the kiosk functions as user device 10, and in other embodiments, as an input device for a type of user device 10 such as a smart phone or iPad. In some embodiments, a customer is offered an option to pre-authenticate a purchase and associate an authenticated branded product with their user account when making an in-person and/or online purchase.

In some embodiments, authentication of a branded product is integrated with sharing an image or other content related to the branded product. The share symbol 1330 option provides a means of generating a shareable version of the product interaction. In some embodiments, this process includes candidate product verification, and in other embodiments, this process is done after a candidate product has been authenticated. In some embodiments, sharing is integrated with a list of pre-authenticated products associated with a user or a group of users.

In this example, when Lee selects the share 1330 option, he is able to add a selfie of himself in the authenticated shirt, a star rating, and a review. He can then select whether to share in one or more of a social media post, as a review in an online retail website, or in a text, and/or in an email to a friend.

In some embodiments, when a candidate product is authenticated as a branded product, the user has the option to add custom content such as a selfie, an image, a video, an audio recording, a text entry, a rating, a review, a testimonial, a styling suggestion, an outfit combination suggestion, a wardrobe context, an unboxing, a demonstration, an exercise suggestion, or a usage suggestion, associated with the product.

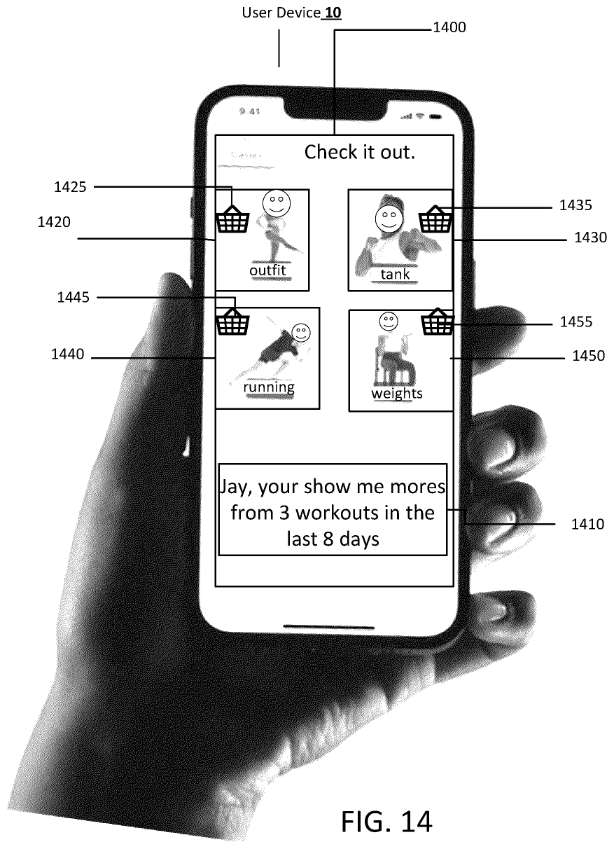

FIG. 14 provides an example user interface associated with generating and providing authenticated branded product interactions in which a number of user selected product interactions are displayed. In this example UI, application 1400 on user device 10 provides a user with the product interactions which he previously selected during their workouts. In this example, a personalized message 1410 is displayed in addition to the product interaction widgets that were generated. Each product interaction widget 1420, 1430, 1440, 1450 opens a product interaction page that displays additional information and access to further aspects of the product interaction. In some embodiments, such as this example, widgets contain additional buttons or controls, such as shopping cart 1425, 1435, 1445, 1455 that enable the user to quickly interact with a key function within the branded product interaction. For example, purchase, or add to a shopping cart, the displayed branded products associated with the product interaction. In some embodiments, the product interactions are displayed rather than a widget representation. In some embodiments, product interactions are displayed within a user interface based on the type of product interaction such that a user may navigate to a part of the user interface that contains specific product interaction types such as demos, sample exercises, simulations, promotions, games, recipes, and quick tips.

In this example, widget 1420 enables the user, Lee, to purchase and/or interact with a combination of branded products that are represented by a single, or inter-related, set of product interactions. In this example, widget 1430 represents a single authenticated branded product “tank”. In this example, widget 1440 represents a product type associated with a selected product interaction. In some embodiments, a product interaction that provides a collection of items associated with the selected authenticated branded product interaction is generated. In some embodiments, this type of product interaction is generated for a user when metadata associated with the user suggests that offering a broader set of products in the product interaction type would benefit the user. In this case, Lee has not purchased running gear in the past and selected a product interaction associated with a pair of running shorts during a beginner runner workout. Based on this context, Lee is provided with a running product interaction 1440 that features the shorts that Lee engaged with and also includes additional gear. Product interactions may be generated for authenticated branded accessories, such as weights 1450, in addition to apparel or other types of products.

These product interactions may be provided embedded within another application such as a fitness class application, an online retail application, a social media application, a membership tool application, a virtual environment, an augmented reality environment, a game environment, or a mixed reality environment.

As is evident in these examples, a range of data and metadata inputs, may be evaluated to determine: whether a candidate product is authentic; whether to provide an indication, and what type of indication to provide; and/or whether to provide one or more authenticated branded product interactions to a user.

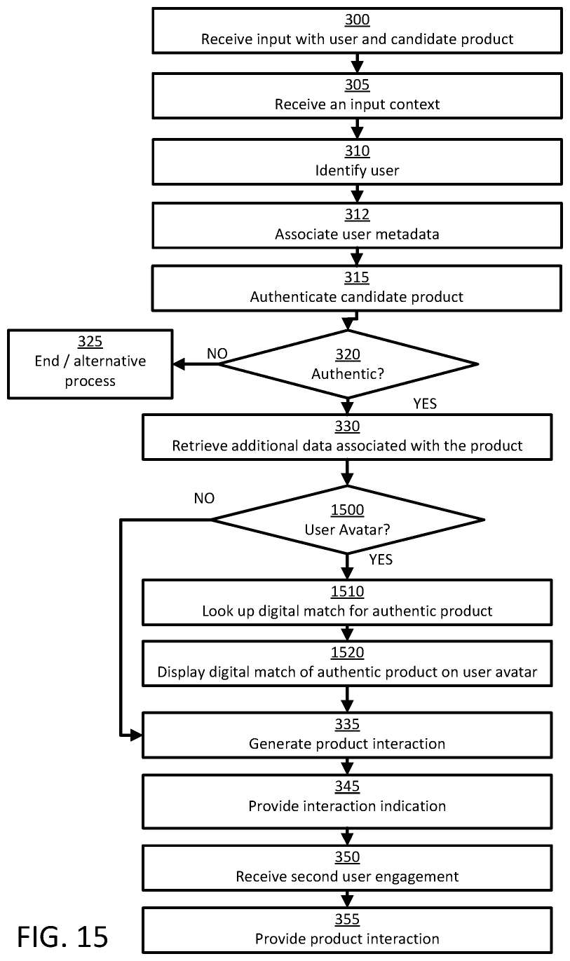

FIG. 15 shows an example method of generating a product interaction based on an input with additional steps for determining if a user is displaying an avatar in the user interface and displaying a digital version of an authenticated branded product according to embodiments described herein.

FIG. 15 depicts a similar to the process in FIG. 3 with additional steps for determining if a user is displaying an avatar in the user interface and displaying a digital version of an authenticated branded product. For example, steps 1500-1520 can be used for determining if a user is displaying an avatar in the user interface and displaying a digital version of an authenticated branded product. Step 1500 involves determining a user avatar, which may be an avatar based on the user's own appearance, or not. Step 1510 involves determining a digital match for an authentic product. This operation can use data from 330 including color, style, season, and, in some embodiments, size. Step 1520 can involve displaying a digital match of the authentic product on a user avatar. This step 1520 may also add an interaction indication, visual indication of authenticated branded product to the digital representation of the product, and other types of visualizations. In one embodiment, an avatar without an authenticated branded product might be displayed in grey or neutral apparel unless an authenticated branded product is worn, and then a digital representation of that authentic branded product would be displayed. In other embodiments a halo, glow, shimmer, sparkle, or other such visual effect might be added to the authenticated branded product represented digitally to indicate the availability of a product interaction. This workflow applies to standard avatar of first user displayed instead of photorealism of first user as well as A/R, V/R, and mixed reality.

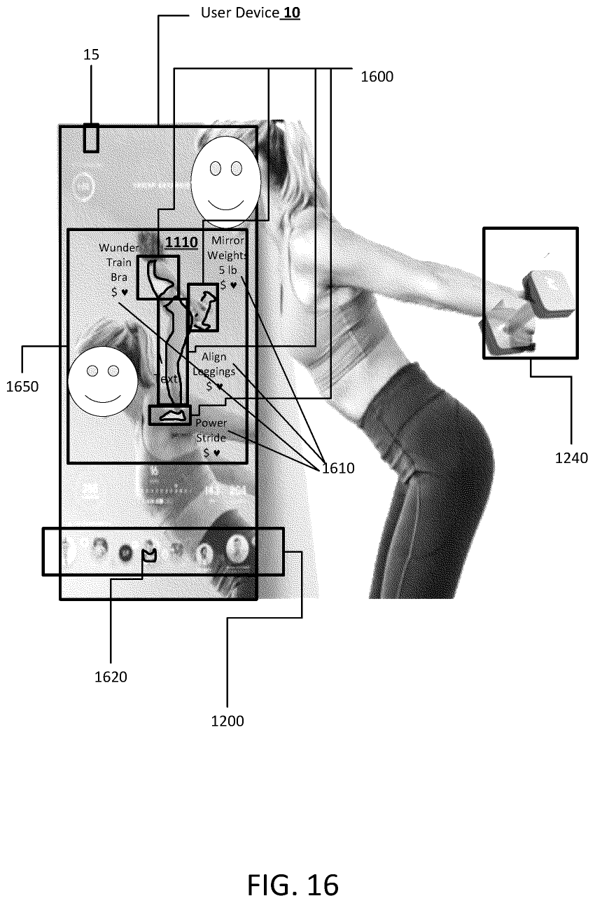

FIG. 16 shows an example user interface related to generating and/or providing a product interaction with an overlay effect according to embodiments described herein.

FIG. 16 provides a user interface, similar to the user interface of FIG. 12 but with an overlay effect and individual items highlighted. The highlighting is associated with the specific authenticated branded products displayed (indicated as an outline, but it can be a number of effects such as increased visual dimensionality, sparkle effect, halo, shine, color in a desaturated UI display, etc.). Individual branded products are identified with UI elements (highlighted perimeter shown) 1600 (and 1620 on non-instructor user). Product interaction 1650 overlay is displayed (in one example embodiment by default) with text/controls (buy/like shown) for the identified branded products 1610. In some embodiments, the overlay adjusts based on the specific branded product location on the screen as the first user moves. In some embodiments, the second user is able to make a grabbing gesture toward an identified branded product and add it to their shopping cart which is accompanied by a visual of pulling the branded product off the first user displaying it. In some embodiments, an additional outfit identifier (not shown) is added in addition to the individual authenticated branded products.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more, unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

The technical solution of embodiments may be in the form of a software product. The software product may be stored in a non-volatile or non-transitory storage medium. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A computer system for providing a user device with a branded product interaction to activate, trigger, or present the branded product interaction at a visual display, the branded product interaction associated with a specific authenticated branded product depicted in a rendering of a first user and one or more branded product, the system comprising:
a user device comprising a hardware processor, and an interface to receive a branded product interaction; and activate, trigger, or present the product interaction at a visual display, wherein the branded product interaction comprises a visual interaction;
at least one controller that performs measurements or operations relating to the user device with the branded product interaction with a specific authenticated branded product;
a communication interface to transmit the branded product interaction associated with the specific authenticated branded product;
one or more non-transitory memory storing a trained interaction model, a product model, and/or a user model;
a hardware processor programmed with executable instructions for generating the branded product interaction associated with the specific branded product depicted in a rendering of a first user and one or more branded product, wherein the hardware processor:
receives a rendering of a first user and a candidate product;
receives input data associated with the rendering including user data, and context data;
evaluates the rendering to determine whether the candidate product is an authentic branded product based on product data, user data, and product data associated with user data;
receives product data associated with an authenticated branded product;
determines one or more product interaction types to generate based on the intervention model, branded product data, product type data, and/or context data;
generates one or more product interactions, the one or more product interactions comprising one or more visual elements of the visual interaction;
evaluates displaying a product interaction indication in association with a representation of the rendering of a first user and one or more branded product;
receives a second user engagement with the representation of the rendering of a first user and one or more branded product; and
provides the one or more product interactions to the user device to activate, trigger, or present the product interaction at the visual display for display of the one or more visual elements as part of the product interaction.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A computer implemented method for generating output instructions for a product interaction with a branded product to activate, trigger, or present the product interaction, the method comprising:
receiving, using a hardware processor, input data that includes a rendering of a first user and a candidate product;
receiving, using a hardware processor, metadata related to the rendering of a first user and a candidate product;
identifying, using a hardware processor, the first user associated with the rendering;
authenticating, using a hardware processor, based on the rendering and the metadata, whether the candidate product displayed is a branded product;
retrieving additional data associated with the product; and
generating a branded product interaction to activate, trigger, or present the product interaction.

32. The computer implemented method for generating output instructions for a product interaction with a branded product of claim 31 further comprising performing measurements using one or more sensors for receiving the input depicting the first user and the one or more displayed candidate product.

33. The computer implemented method for generating output instructions for a product interaction with a branded product of claim 31 further comprising transmitting control signals to one or more sensors to perform measurements using the one or more sensors for receiving the input depicting the first user and the one or more displayed candidate products.

34. The computer implemented method for generating output instructions for a product interaction with a branded product of claim 31 further comprising using computer vision to extract product data from image or video data received as the input to authenticate whether the one or more displayed candidate product is associated with the branded product to determine one or more authenticated displayed product.

35. The computer implemented method for generating output instructions for a product interaction with a branded product of claim 31 further comprising causing an electronic device to display the product interaction as a visualization on a user interface as part of generating the branded product interaction.

36. The computer implemented method for generating output instructions for a product interaction with a branded product of claim 31 the method further comprising evaluating whether the rendering of a first user and a candidate product contains a sufficient visible portion of the candidate product to identify whether the candidate product is an authentic branded product.

37. The computer implemented method for generating output instructions for a product interaction with a branded product of claim 31 wherein the candidate product is an item of apparel.

38. The computer implemented method for generating output instructions for a product interaction with a branded product of claim 31 the method further comprising identifying whether there are more than one candidate products within the rendering of a first user and a candidate product and if there are more than one candidate products authenticating each of the candidate products displayed.

39. The computer implemented method of claim 31 further comprising generating a product interaction that combines each of the more than one candidate product in a combined product interaction.

40. The computer implemented method for generating output instructions for a product interaction with a branded product of claim 31 wherein identifying, using a hardware processor, the first user associated with the rendering further comprises identifying an anonymous user instance and validating the product authenticity based on specific aspects related to the product.

41. The computer implemented method for generating output instructions for a product interaction with a branded product of claim 31 further comprises:
receiving one or more of a user model, and product model, and/or a retail model;
evaluating the candidate product against one or more of a product model, a user model, and/or pre-authenticated branded product metadata associated with user data to authenticate whether the candidate product is a branded product.

42. (canceled)

43. The computer implemented method for generating output instructions for a product interaction with a branded product of claim 31 further comprising evaluating whether the authentic branded product is available in a specific region, gender designation, market, color, size, pattern, version, membership level, and/or season.

44. The computer implemented method for generating output instructions for a product interaction with a branded product of claim 31 where authenticating, using a hardware processor, based on the rendering and the metadata, whether the candidate product is a branded product, further comprises evaluating the candidate product against one or more of a product data model, and/or a pre-authenticated branded product metadata associated with user data.

45. The computer implemented method for generating output instructions for a product interaction with a branded product of claim 31 further comprising instructions for authenticating the candidate product is a branded product by detecting and reading one or more of a 1D (linear) barcode, 2D barcode, 3D barcode, watermark, microtext, hologram, forensic taggants, a sensor, circuit, printed code, UV code, infrared code, printed smart tag, smart token, RFID technology tag, BLE tag, and/or RTLS tag within, attached to, or on the candidate product.

46. (canceled)

47. The computer implemented method for generating output instructions for a product interaction with a branded product of claim 31 further comprising instructions to add to a graphical representation associated with the first user input an indicator that there are one or more product interactions associated with the first user input.

48. The computer implemented method for generating output instructions for a product interaction with a branded product of claim 31 the method further comprising receiving an input from a second user engaging with the interaction indicator and providing the product interaction to the second user.

49. The computer implemented method for generating output instructions for a product interaction with a branded product of claim 31 the method further comprising receiving metadata associated with a second user the metadata comprising one or more of a user region, user size, user purchase history, user wishlist, user viewed product list, user activity, user activity history, user planned activity, user preference associated with color, feel state, activity, and/or fabric type.

50. The computer implemented method for generating output instructions for a product interaction with a branded product of claim 31 further comprising instructions to determine a substitute branded product based on one or more of the authenticated displayed product availability in an inventory, availability in a preferred region, availability in a preferred size, availability in a preferred option, availability for a preferred gender, and/or an updated version associated with the branded product.

51. (canceled)

52. The computer implemented method for generating output instructions for a product interaction with a branded product of claim 31 wherein the product interaction is one or more of adding the displayed branded product to a view history, adding the displayed branded product to a customized storefront, adding identification values associated with the displayed branded product to an incentive system, displaying a closet tour associated with the branded product, displaying environmental and/or sustainability factors associated with a branded product, displaying a 360 degree view of the product, displaying an interactive simulation of the product, displaying a pop-up with additional product details for the displayed branded product, providing a link to purchase the displayed branded product, providing a link to receive a special offer related to the displayed branded product, displaying an interactive product site for the displayed branded product, providing a link to related products for the displayed branded product, providing a link to other products related to the user associated with the displayed branded product, displaying activities associated with the displayed branded product, displaying activities associated with the first user associated with the displayed branded product, displaying communities associated with the displayed branded product, and/or displaying communities associated with the first user associated with the displayed branded product.

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled).

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)
